(19) United States
(12) Patent Application Publication
(10) Pub. No.: US 2009/0062430 A1
(43) Pub. Date: Mar. 5, 2009

(54) Epoxy Resin Composition for Sealing and Electronic Component Device

(76) Inventors: Ryoichi Ikezawa, Ibaraki (JP); Seiichi Akagi, Ibaraki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/097,319

(22) PCT Filed: Dec. 7, 2006
(86) PCT No.: PCT/JP2006/324442

§ 371 Date: Jun. 13, 2008

(30) Foreign Application Priority Data
Dec. 13, 2005 (JP) 2005-358942
Oct. 19, 2006 (JP) 2006-285141

(51) Int. Cl. C08G 59/62

(52) U.S. Cl. 523/400; 525/480; 525/534

(57) ABSTRACT

The invention relates to an epoxy resin composition for sealing comprising (A) an epoxy resin, and (B) a curing agent, wherein the following is comprised as the curing agent (B): (C) a compound or compounds represented by the following general formula (I) in which n is or n's are each an integer of 1 to 10, and m is or m's are each an integer of 1 to 10:

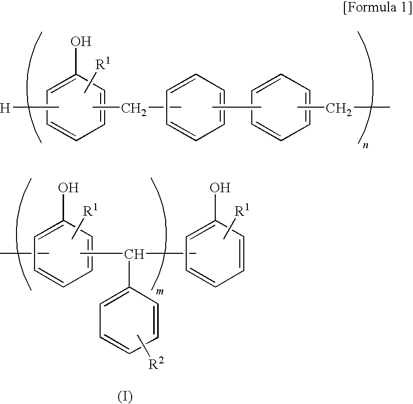

wherein R¹ is selected from a hydrogen atom and substituted or unsubstituted monovalent hydrocarbon groups having 1 to 10 carbon atoms, and R² is selected from a hydrogen atom and substituted or unsubstituted monovalent hydrocarbon groups having 1 to 10 carbon atoms. This makes it possible to provide a halogen-free and antimony-free epoxy resin composition for sealing which is good in flame retardancy without lowering reliabilities, such as moldability, reflow resistance, humidity resistance and high-temperature-standing property, and an electron component device equipped with an element sealed with this composition.

### TECHNICAL FIELD

The present invention relates to an epoxy resin composition for sealing, and an electronic component device equipped with an element sealed with this composition.

### BACKGROUND ART

Hitherto, in the field of the sealing of elements in electronic component devices, such as transistors or ICs, resin-sealing has become a main current from the viewpoint of productivity, costs and others, and epoxy resin molding materials have widely been used. The reason therefor is that epoxy resin has various well-balanced properties, such as electric characteristics, humidity resistance, heat resistance, mechanical characteristics, and adhesion to inserting articles. Achievement of flame-retardancy of these epoxy resin molding materials for sealing is carried out mainly by a combination of a brominated resin, such as diglycidyl ether of tetrabromobisphenol A, with antimony oxide.

In recent years, law regulations about bromine based compounds, such as ROHS and WEEE, have been activated from the viewpoint of environmental protection, and epoxy resin molding materials for sealing have also been required not to contain any halogen (bromine) nor antimony. It is known that a bromine compound produces a bad effect on the high-temperature-standing property of plastic-sealed ICs. From this viewpoint also, the amount of brominated resin is desired to be decreased.

Thus, the following methods are suggested as methods for achieving flame-retardancy without using brominated resin or antimony oxide: methods using a flame-retardant other than halogens and antimony, such as a method using red phosphorus (see, for example, Japanese Patent Application Laid-Open (JP-A) No. 9-227765), a method using a phosphoric acid ester compound (see, for example, JP-A-9-235449), a method using a phosphazene compound (see, for example, JP-A-8-225714), a method using a metal hydroxide (see, for example, JP-A-9-241483), a method using a metal hydroxide and a metal oxide together (see, for example, JP-A-9-100337), a method using a cyclopentadienyl compound such as ferrocene (JP-A-11-269349), a method using an organometallic compound such as copper acetylacetonate (see, for example, Hiroshi Kato, Monthly Functional Material, CMC Publishing Co., Ltd., 11(6), p. 34 (1991)), and others. Furthermore, a method making the ratio of a filler higher (see, for example, JP-A-7-82343) is tried. Nowadays, methods using a resin high in flame retardancy (see, for example, JP-A-11-140277) and other methods are tried.

### DISCLOSURE OF THE INVENTION

However, the case of using red phosphorus in epoxy resin molding material for sealing has a problem that the humidity resistance declines, the case of using a phosphoric acid ester compound or a phosphazene compound has a problem that the material is plasticized so that the moldability or the humidity resistance thereof lowers. The case of using a metal hydroxide has a problem that the fluidity or the releasability from a mold lowers. The case of using a metal oxide or the case of making the ratio of a filler high has a problem that the fluidity lowers. The case of using an organometallic compound such as copper acetylacetonate has a problem that the compound hinders curing reaction so that the moldability deteriorates. Furthermore, in the methods that have been so far invented wherein a resin high in flame retardancy is used, the flame retardancy does not sufficiently satisfy UL-94 V-0, which is required for electron component devices.

As described above, any one of the halogen-free flame retardants, the antimony-free flame retardants, the method of making the ratio of a filler high, and the methods using a resin high in flame retardancy has neither yet given reliabilities, such as moldability, reflow resistance, humidity resistance and high-temperature-standing property, equivalent to those of epoxy resin molding material for sealing wherein brominated resin and antimony oxide are used together, nor flame retardancy equivalent thereto.

In light of such a situation, the present invention has been made, and provides a halogen-free and antimony-free epoxy resin material for sealing which is good in flame retardancy without lowering moldability and reliabilities such as reflow resistance, humidity resistance and high-temperature-standing property, and an electron component device equipped with an element sealed with this material.

In order to solve the above-mentioned problems, the inventors have repeatedly made eager investigations so as to find out that the object can be attained by means of an epoxy resin composition for sealing into which a specific compound is incorporated. Thus, the present invention has been made.

The present invention relates to the following (1) to (17):

(1) An epoxy resin composition for sealing comprising (A) an epoxy resin, and (B) a curing agent, wherein the following is comprised as the curing agent (B): (C) a compound or compounds represented by the following general formula (I) in which n is or n's are each an integer of 1 to 10, and m is or m's are each an integer of 1 to 10:

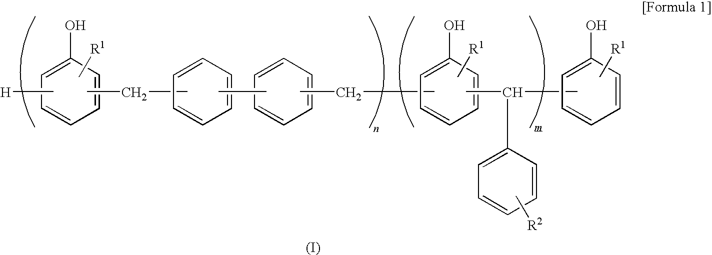

wherein R¹ is selected from a hydrogen atom and substituted or unsubstituted monovalent hydrocarbon groups having 1 to 10 carbon atoms, and R² is selected from a hydrogen atom and substituted or unsubstituted monovalent hydrocarbon groups having 1 to 10 carbon atoms.

(2) The epoxy resin composition for sealing according to the (1) above, wherein the ratio between the average N of n's of the compounds represented by the general formula (I) and the average M of m's of the compounds, the ratio of M/(N+M), is from 0.05 to 0.5.

(3) The epoxy resin composition for sealing according to the (1) above, wherein the ratio between the average N of n's of the compounds represented by the general formula (I) and the average M of m's of the compounds, the ratio of M/(N+M), is from 0.1 to 0.3.

(4) The epoxy resin composition for sealing according to anyone of the (1) to (3) above, wherein the epoxy resin (A) comprises at least one of biphenyl type epoxy resin, bisphenol F type epoxy resin, stylbene type epoxy resin, sulfur-atom-containing epoxy resin, Novolak type epoxy resin, dicyclopentadiene type epoxy resin, naphthalene type epoxy resin, triphenylmethane type epoxy resin, biphenylene type epoxy resin, and naphthol/aralkyl type phenol resin.

(5) The epoxy resin composition for sealing according to any one of the (1) to (4) above, wherein the compound(s) (C) represented by the general formula (I) is/are contained in the curing agent (B) in an amount of 40 to 100% by mass.

(6) The epoxy resin composition for sealing according to any one of the (1) to (4) above, wherein the compound(s) (C) represented by the general formula (I) is/are contained in the curing agent (B) in an amount of 60 to 100% by mass.

(7) The epoxy resin composition for sealing according to any one of the (1) to (6) above, wherein the curing agent (B) comprises at least one of biphenylene type phenol/aralkyl resin, phenol/aralkyl resin, naphthol/aralkyl resin, dicyclopentadiene type phenol resin, triphenylmethane type phenol resin, and Novolak type phenol resin.

(8) The epoxy resin composition for sealing according to any one of the (1) to (7) above, further comprising (D) a curing promoter.

(9) The epoxy resin composition for sealing according to the (8) above, wherein the curing promoter (D) is triphenylphosphine.

(10) The epoxy resin composition for sealing according to the (8) above, wherein the curing promoter (D) is an adduct of a tertiary phosphine compound and a quinone compound.

(11) The epoxy resin composition for sealing according to any one of the (1) to (10) above, further comprising (E) an inorganic filler.

(12) The epoxy resin composition for sealing according to the (11) above, wherein the content by percentage of the inorganic filler (E) is from 60 to 95% by mass of the epoxy resin composition for sealing.

(13) The epoxy resin composition for sealing according to the (11) above, wherein the content by percentage of the inorganic filler (E) is from 70 to 90% by mass of the epoxy resin composition for sealing.

(14) The epoxy resin composition for sealing according to any one of the (1) to (13) above, further comprising (F) a coupling agent.

(15) The epoxy resin composition for sealing according to the (14) above, wherein the coupling agent (F) comprises a silane coupling agent having a secondary amino group.

(16) The epoxy resin composition for sealing according to the (15) above, wherein the silane coupling agent having a secondary amino group comprises a compound represented by the following general formula (II):

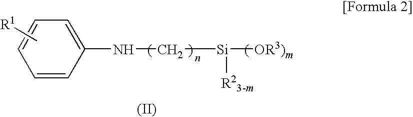

wherein R¹ is selected from a hydrogen atom, and alkyl groups having 1 to 6 carbon atoms, and alkoxy groups having 1 to 2 carbon atoms, R² is selected from alkyl groups having 1 to 6 carbon atoms, and a phenyl group, R³ is selected from a methyl group or an ethyl group, n represents an integer of 1 to 6, and m represents an integer of 1 to 3.

(17) An electron component device equipped with an element sealed with the epoxy resin composition for sealing according to any one of the (1) to (16) above.

The disclosure of the present application is concerned with subject matters described in Japanese Patent Application No. 2005-358942 filed on Dec. 13, 2005, and Japanese Patent Application No. 2006-285141 filed on Oct. 19, 2006, and the disclosure contents therein are incorporated herein by reference.

### BEST MODE FOR CARRYING OUT THE INVENTION

The epoxy resin (A) used in the invention may be an epoxy resin known in the prior art. Examples of the epoxy resin that can be used include an epoxidized Novolak resin obtained by condensing or cocondensing a phenol, such as phenol, cresol, xylenol, resorcin, catechol, bisphenol A or bisphenol F, and/or a naphthol, such as α-naphthol, β-naphthol or dihydroxynaphthalene, with a compound having an aldehyde group, such as formaldehyde, acetoaldehyde, propionaldehyde, benzaldehyde or salicylaldehyde, in the presence of an acidic catalyst, typical examples of the resin being phenol Novolak type epoxy resin, o-cresol Novolak type epoxy resin, and epoxy resin having a triphenylmethane skeleton; a diglycidyl ether such as bisphenol A, bisphenol F, bisphenol S, or biphenol which may be alkyl-substituted, or unsubstituted; a stylbene type epoxy resin; a hydroquinone type epoxy resin; a glycidyl ester type epoxy resin obtained by reaction of a polybasic acid, such as fumaric acid or dimer acid, with epichlorohydrin; a glycidylamine type epoxy resin obtained by reaction of a polyamine, such as diaminodiphenylmethane or isocyanuric acid, with epichlorohydrin; an epoxidized cocondensed resin made from dicyclopentadiene and a phenol; an epoxy resin having a naphthalene ring; an epoxidized aralkyl type phenol resin, such as phenol/aralkyl resin containing a xylylene skeleton or biphenylene skeleton, and naphthol/aralkyl resin; a trimethylolpropane type epoxy resin; a terpene modified epoxy resin; a linear aliphatic epoxy resin obtained by oxidizing olefin bonds with a peracid such as acetic peracid; an alicyclic epoxy resin; and a sulfur-atom-containing epoxy resin. These may be used alone or in combination of two or more thereof.

Of the resins, biphenyl type epoxy resin, bisphenol F type epoxy resin, stylbene type epoxy resin and sulfur-atom-containing epoxy resin are preferred from the viewpoint of fluidity and reflow resistance; Novolak type epoxy resin is preferred from the viewpoint of curability; dicyclopentadiene type epoxy resin is preferred from the viewpoint of low hygroscopicity; naphthalene type epoxy resin and triphenylmethane type epoxy resin are preferred from the viewpoint of heat resistance and low warpage; and biphenylene type epoxy resin and naphthol/aralkyl type epoxy resin are preferred from the viewpoint of flame retardancy. It is preferred that at least one of these resins is contained.

The biphenyl type epoxy resin may be, for example, an epoxy resin represented by a general formula (III) illustrated below, the bisphenol F type epoxy resin may be, for example, an epoxy resin represented by a general formula (IV) illustrated below, the stylbene type epoxy resin may be, for example, an epoxy resin represented by a general formula (V) illustrated below, and the sulfur-atom-containing epoxy resin may be, for example, an epoxy resin represented by a general formula (VI) illustrated below.

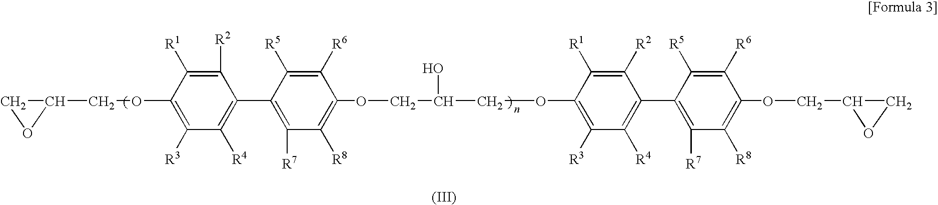

wherein R¹ to R⁸ are selected from hydrogen atoms, and substituted or unsubstituted monovalent hydrocarbon groups having 1 to 10 carbon atoms, and may wholly be the same or different, and n represents an integer of 0 to 3.

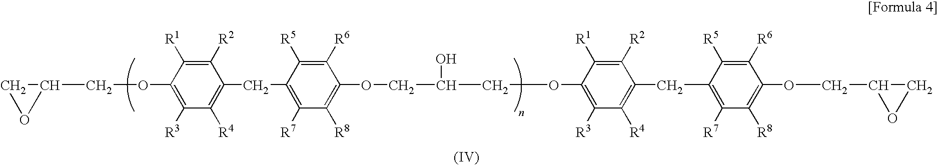

wherein R¹ to R⁸ are selected from hydrogen atoms, alkyl groups having 1 to 10 carbon atoms, alkoxyl groups having 1 to 10 carbon atoms, aryl groups having 6 to 10 carbon atoms, and aralkyl groups having 6 to 10 carbon atoms, and may wholly be the same or different, and n represents an integer of 0 to 3.

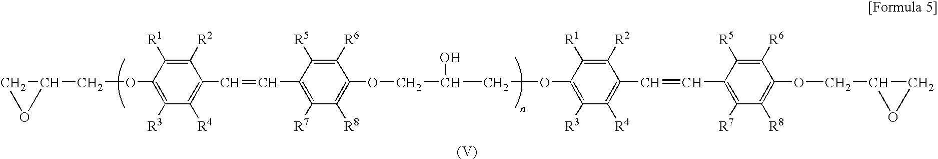

wherein R¹ to R⁸ are selected from hydrogen atoms, and substituted or unsubstituted monovalent hydrocarbon groups having 1 to 5 carbon atoms, and may wholly be the same or different, and n represents an integer of 0 to 10.

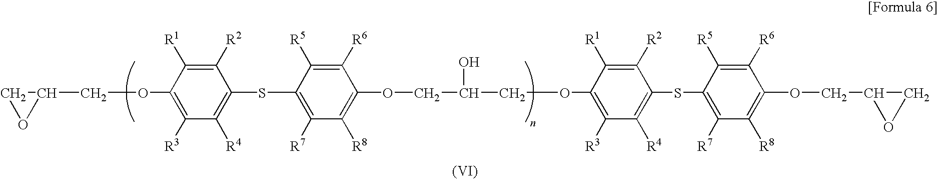

wherein R¹ to R⁸ are selected from hydrogen atoms, substituted or unsubstituted alkyl groups having 1 to 10 carbon atoms, and substituted or unsubstituted alkoxy groups having 1 to 10 carbon atoms, and may wholly be the same or different, and n represents an integer of 0 to 3.

Examples of the biphenyl type epoxy resin represented by the general formula (III) include epoxy resin made mainly of 4,4′-bis(2,3-epoxypropoxy)biphenyl or 4,4′-bis(2,3-epoxypropoxy)-3,3′,5,5′-tetramethylbiphenyl, and epoxy resin obtained by causing epichlorohydrin to react with 4,4′-biphenyl or 4,4′-(3,3′,5,5′-tetramethyl)biphenol. Of the resins, epoxy resin made mainly of 4,4′-bis(2,3-epoxypropoxy)-3,3′,5,5′-tetramethylbiphenyl is preferred. Such a compound may be YX-4000 (tradename) manufactured by Japan Epoxy Resins Co., Ltd., or the like as a commercially available product.

The bisphenol F type epoxy resin represented by the general formula (IV) is, for example, YSLV-80XY (trade name), wherein R¹, R³, R⁶ and R⁸ are each a methyl group, R², R⁴, R⁵ and R⁷ are each a hydrogen atom, and n=0, manufactured by Tohto Kasei Co., Ltd. as a commercially available product.

The stylbene type epoxy resin represented by the general formula (V) can be obtained by causing a stylbene type phenol and epichlorohydrin, which are starting materials, to react with each other in the presence of a basic material. Examples of the stylbene type phenol, which is one of the starting materials, include 3-tert-butyl-4,4′-dihydroxy-3′,5,5′-trimethylstylbene, 3-tert-butyl-4,4′-dihydroxy-3′,5′,6-trimethylstylbene, 4,4′-dihydroxy-3,3′,5,5′-tetramethylstylbene, 4,4′-dihydroxy-3,3′-di-tert-butyl-5,5′-dimethylstylbene, and 4,4′-dihydroxy-3,3′-di-tert-butyl-6,6′-dimethylstylbene. Of the compounds, preferred are 3-tert-butyl-4,4′-dihydroxy-3′,5,5′-trimethylstylbene, and 4,4′-dihydroxy-3,3′,5,5′-tetramethylstylbene. These stylbene type phenols may be used alone or in combination of two or more thereof.

Of species of the sulfur-atom-containing epoxy resin represented by the general formula (VI), preferred is epoxy resin wherein R², R³, R⁶ and R⁷ are each a hydrogen atom and R¹, R⁴, R⁵ and R³ are each an alkyl group, and more preferred is epoxy resin wherein R², R³, R⁶ and R⁷ are each a hydrogen atom, R¹ and R⁸ are each a tert-butyl group, and R⁴ and R⁵ are each a methyl group. Such a compound may be YSLV-120TE (trade name) manufactured by Tohto Kasei Co., Ltd., or the like as a commercially available product. These epoxy resins may be used alone or in combination of two or more thereof.

The Novolak type epoxy resin is, for example, an epoxy resin represented by the following general formula (VII):

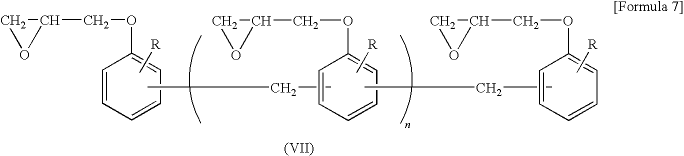

wherein R is selected from a hydrogen atom, and substituted or unsubstituted monovalent hydrocarbon groups and alkoxyl groups having 1 to 10 carbon atoms, and n represents an integer of 0 to 10.

The Novolak type epoxy resin represented by the general formula (VII) can easily be obtained by causing a Novolak type phenol resin to react with epichlorohydrin. In R in the general formula (VII), preferred are alkyl groups having 1 to 10 carbon atoms, such as methyl, ethyl, propyl, butyl, isopropyl, and isobutyl groups, and alkoxyl groups having 1 to 10 carbon atoms, such as methoxy, ethoxy, propoxy, and butoxy groups; and more preferred are a hydrogen atom and a methyl group. n is preferably an integer of 0 to 3. Of species of the Novolak type epoxy resin represented by the general formula (VII), preferred is o-cresol Novolak type epoxy resin. Such a compound may be EOCN-1020 (trade name) manufactured by Nippon Kayaku Co., Ltd. or the like as a commercially available product.

The dicyclopentadiene type epoxy resin is, for example, an epoxy resin represented by the following general formula (VIII):

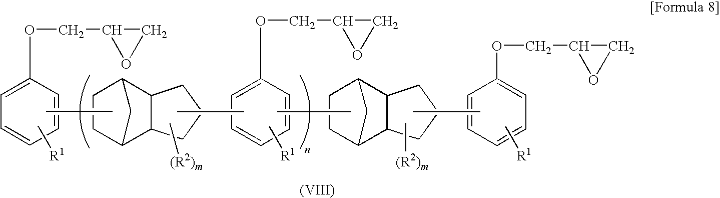

wherein R¹ and R² are each independently selected from hydrogen atoms and substituted or unsubstituted monovalent hydrocarbon groups having 1 to 10 carbon atoms, n represents an integer of 0 to 10, and m represents an integer of 0 to 6.

Examples of R¹ in the formula (VIII) include a hydrogen atom; and substituted or unsubstituted monovalent hydrocarbon groups having 1 to 5 carbon atoms, for example, alkyl groups such as methyl, ethyl, propyl, butyl, isopropyl and tert-butyl groups, alkenyl groups such as vinyl, allyl and butenyl groups, halogenated alkyl groups, amino-group-substituted alkyl groups, and mercapto-group-substituted alkyl groups. Of the examples, preferred are alkyl groups such as methyl and ethyl groups, and a hydrogen atom. More preferred are a methyl group and a hydrogen atom. Examples of R² include a hydrogen atom; and substituted or unsubstituted monovalent hydrocarbon groups having 1 to 5 carbon atoms, for example, alkyl groups such as methyl, ethyl, propyl, butyl, isopropyl and tert-butyl groups, alkenyl groups such as vinyl, allyl and butenyl groups, halogenated alkyl groups, amino-group-substituted alkyl groups, and mercapto-group-substituted alkyl groups. Of the examples, a hydrogen atom is preferred. Such a compound may be HP-7200 (trade name) manufactured by Dainippon Ink & Chemicals, Inc. or the like as a commercially available product.

The naphthalene type epoxy resin is, for example, an epoxy resin represented by a general formula (IX) illustrated below, and the triphenylmethane type epoxy resin is, for example, an epoxy resin represented by a general formula (X) illustrated below.

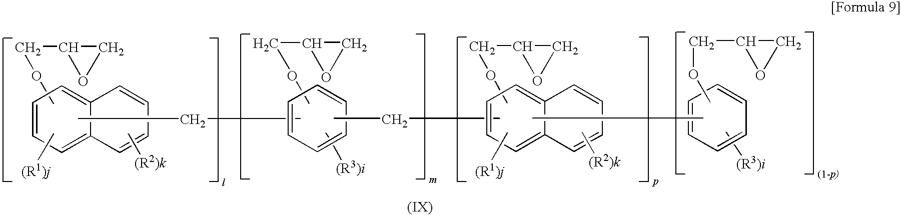

wherein R¹ to R³ is selected from hydrogen atoms, and substituted or unsubstituted monovalent hydrocarbon groups having 1 to 12 carbon atoms, and may wholly be the same or different; p is 1 or 0, 1 and m are each an integer of 0 to 11, and p, 1 and m are selected to set (1+m) to an integer of 1 to 11, and set (1+p) to an integer of 1 to 12; i represents an integer of 0 to 3; j represents an integer of 0 to 2; and k represents an integer of 0 to 4.

Examples of the naphthalene type epoxy resin represented by the general formula (IX) include a random copolymer containing the structural units the number of which is 1, and the structural units the number of which is m at random, an alternating copolymer containing the units alternately, a copolymer containing the units regularly, and a block copolymer containing the units in the form of blocks. These may be used alone or in combination of two or more thereof. The above-mentioned compound wherein R¹ and R² are each a hydrogen atom and R³ is a methyl group may be NC-7000 (trade name) manufactured by Nippon Kayaku Co., Ltd. or the like as a commercially available product.

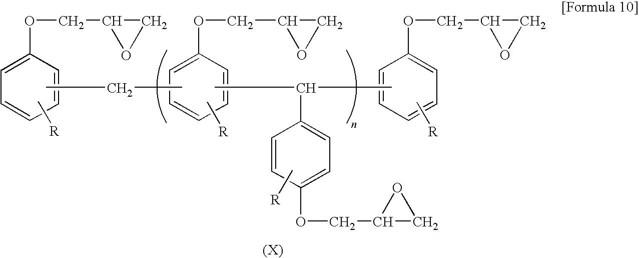

wherein R is selected from a hydrogen atom, and substituted or unsubstituted monovalent hydrocarbon groups having 1 to 10 carbon atoms, and n represents an integer of 1 to 10.

The triphenylmethane type epoxy resin represented by the general formula (X) may be, for example, E-1032 (trade name), wherein R is a hydrogen atom, manufactured by Japan Epoxy Resins Co., Ltd. as a commercially available product.

The biphenylene type epoxy resin is, for example, an epoxy resin represented by the following general formula (XI), wherein a biphenylene-skeleton-containing phenol/aralkyl resin is epoxidized, and the naphthol/aralkyl type epoxy resin is, for example, an epoxy resin represented by the following general formula (XII):

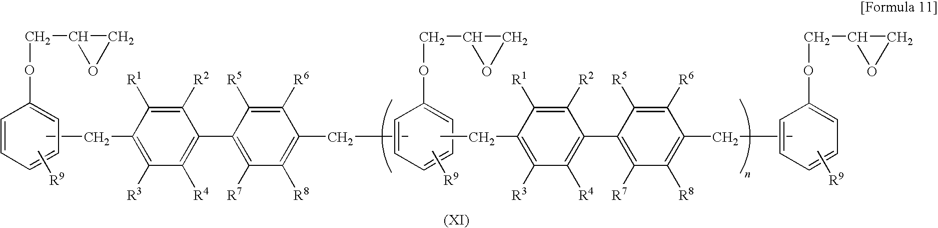

wherein R¹ to R⁹ may wholly be the same or different, and are each selected from a hydrogen atom, alkyl groups having 1 to 10 carbon atoms, such as methyl, ethyl, propyl, butyl, isopropyl and isobutyl groups, alkoxyl groups having 1 to 10 carbon atoms, such as methoxy, ethoxy, propoxy and butoxy groups, aryl groups having 6 to 10 carbon atoms, such as phenyl, tolyl and xylyl groups, and aralkyl groups having 6 to 10 carbon atoms, such as benzyl and phenethyl groups, and are each preferably selected from a hydrogen atom and a methyl group, and n represents an integer of 0 to 10.

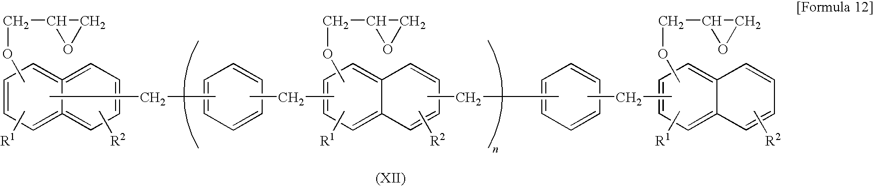

wherein R¹ to R³ are selected from hydrogen atoms, and substituted or unsubstituted monovalent hydrocarbon groups having 1 to 12 carbon atoms, and may wholly be the same or different, and n represents an integer of 1 to 10.

The biphenylene type epoxy resin may be NC-3000 (trade name) manufactured by Nippon Kayaku Co., Ltd. or the like as a commercially available product. The naphthol/aralkyl type epoxy resin may be ESN-175 (trade name) manufactured by Tohto Kasei Co., Ltd. or the like as a commercially available product. These epoxy resins may be used alone or in combination of the two.

As the epoxy resin (A), an epoxy resin having the following structural formula (XIII) may be used:

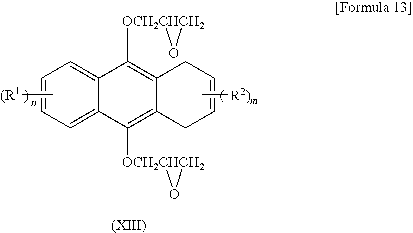

wherein R¹ is selected from substituted or unsubstituted hydrocarbon groups having 1 to 12 carbon atoms, and substituted or unsubstituted alkoxy groups having 1 to 12 carbon atoms, and when plural R's are present, they may wholly be the same or different; n represents an integer of 0 to 4; R² is selected from substituted or unsubstituted hydrocarbon groups having 1 to 12 carbon atoms, and substituted or unsubstituted alkoxy groups having 1 to 12 carbon atoms, and when plural R² s are present, they may wholly be the same or different; and m represents an integer of 0 to 2.

Examples of the epoxy resin represented by the general formula (XIII) include epoxy resins represented by the following general formula (XIV) to (XXXII):

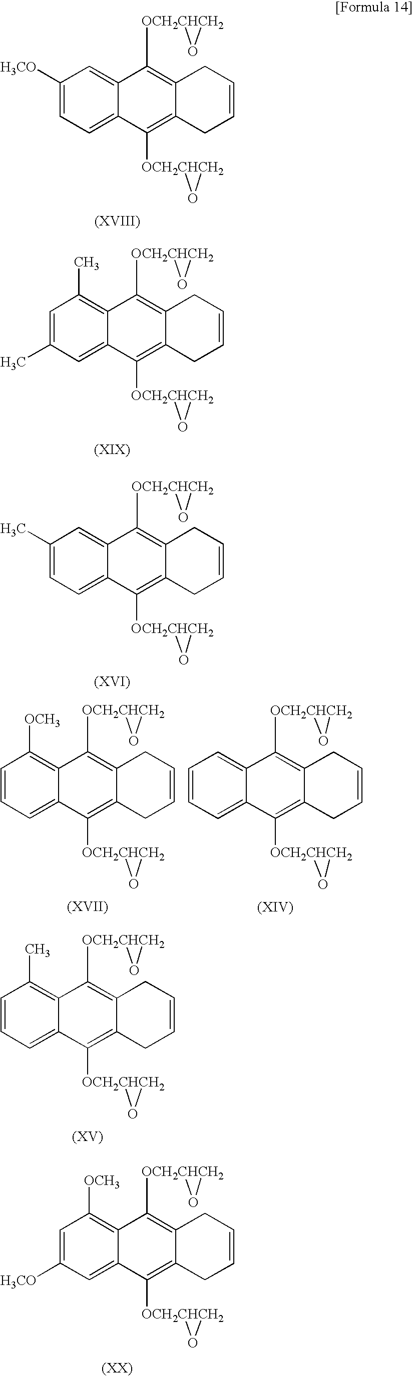

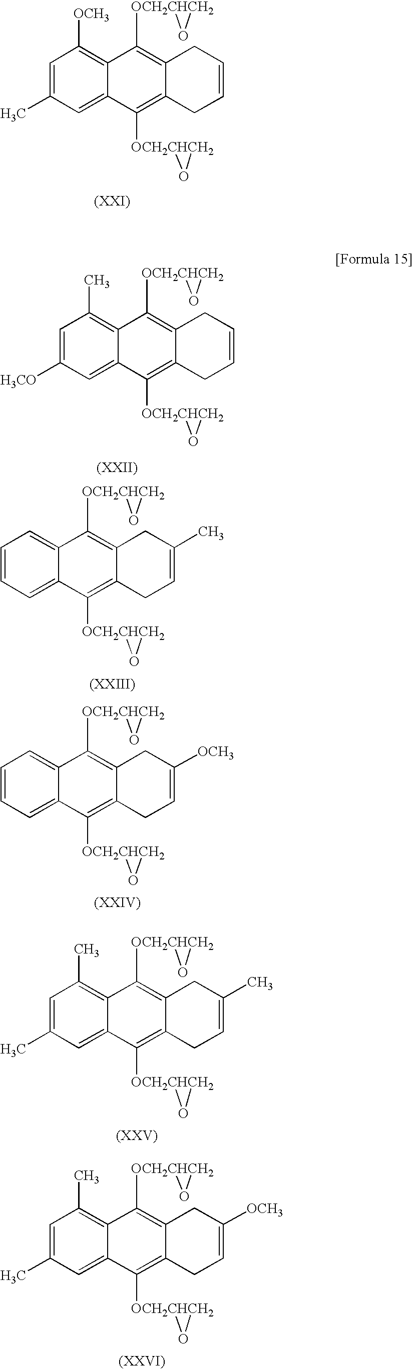

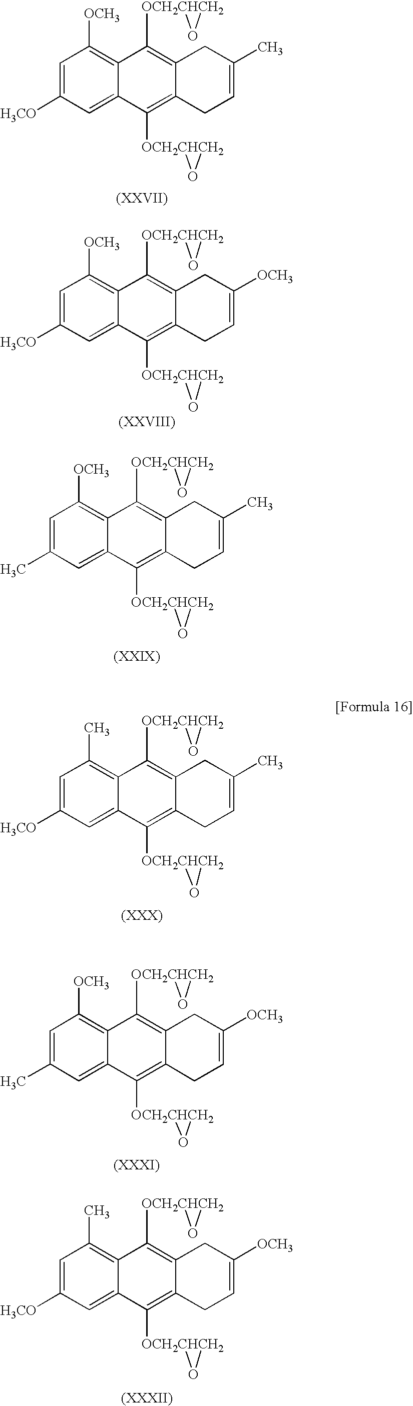

Of these resins, epoxy resin represented by the general formula (XIV) is preferred from the viewpoint of flame retardancy and moldability. Such a compound may be YX-8800 (trade name) manufactured by Japan Epoxy Resins Co., Ltd. or the like as an available product.

A compound represented by the following general formula (XXXIII) may be used:

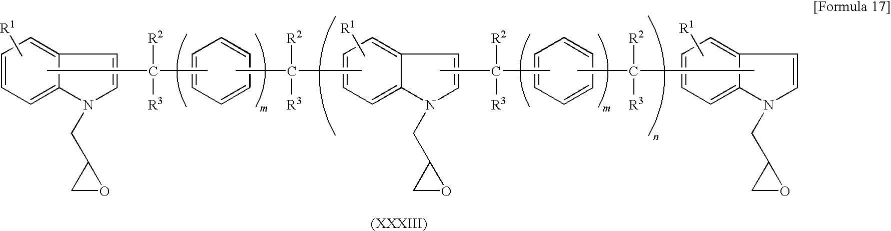

wherein R's are selected from hydrogen atoms, hydroxyl groups, alkyl groups having 1 to 8 carbon atoms, alkenyl groups, alkynyl groups, aryl groups, aralkyl groups, cycloalkyl groups, alkoxy groups having 1 to 6 carbon atoms, alkenyloxy groups, alkynyloxy groups, and aryloxy groups, and may wholly be the same or different; R²s and R³s are selected from hydrogen atoms and alkyl groups having 1 to 6 carbon atoms, and may wholly be the same or different; n represents an integer of 1 to 20; and m represents an integer of 1 to 3.

In the general formula (XXXIII), m is preferably from 1 to 2 from the viewpoint of flame retardancy and curability. n preferably represents an integer of 1 to 20, preferably 1 to 5.

The compound represented by the general formula (XXXIII) is obtained by causing an indole to react with a crosslinking agent in the presence of an acidic catalyst, and then causing the resultant to react with an epichlorohydrin compound. Examples of the substituent R¹ in the indole include a hydrogen atom; and methoxy, ethoxy, vinyl ether, isopropoxy, allyloxy, propargyl ether, butoxy, phenoxy, methyl, ethyl, butyl, n-propyl, isopropyl, vinyl, ethyne, allyl, propargyl, n-amyl, sec-amyl, tert-amyl, cyclohexyl, phenyl, and benzyl groups. The substituent is preferably a hydrogen atom, or an alkyl group having 1 to 3 carbon atoms, more preferably a hydrogen atom.

Examples of a crosslinking group of a general formula (a) illustrated below that can be caused to react with the crosslinking agent include p-xylylene, m-xylylene, 1,4-bisethylidenephenyl, 1,3-bisethylidenephenylene, 1,4-bisisopropylidenephenylene, 1,3-isopropylidenephenylene, 4,4′-bismethylenebiphenyl, 3,4′-bismethylenebiphenyl, 3,3′-bismethylenebiphenyl, 4,4′-bisethylidenebiphenyl, 3,4′-bisethylidenebiphenyl, 3,3′-bisethylidenebiphenyl, 4,4′-bisisoropylidenebiphenyl, 3,4′-bisisopropylidenebiphenyl, and 3,3′-bisisopropylidenebiphenyl groups.

An aldehyde or a ketone such as formaldehyde, acetoaldehyde, propylaldehyde, butylaldehyde, amylaldehyde, benzaldehyde, or acetone may be used together as another crosslinking agent.

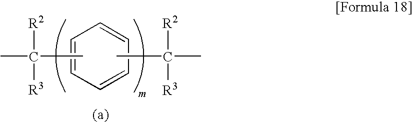

wherein R² and R³ are selected from hydrogen atoms and alkyl groups having 1 to 6 carbon atoms, and may wholly be the same or different; and m represents an integer of 1 to 3.

Examples of the acidic catalyst include hydrochloric acid, sulfuric acid, phosphoric acid, formic acid, oxalic acid, trifluoroacetic acid, p-toluenesulfonic acid, dimethylsulfuric acid, diethylsulfuric acid, zinc chloride, aluminumchloride, iron chloride, trifluoroboric acid, ion exchange resin, activated clay, slice alumina, and zeolite.

The compound represented by the general formula (XXXIII) may be ENP-80 (trade name) manufactured by Tohto Kasei Co., Ltd. or the like as an available product.

The softening point of the compound represented by the general formula (XXXIII) is from 40 to 200° C., preferably from 50 to 160° C., even more preferably from 60 to 120° C. If the point is lower than 40° C., the curability tends to lower. If the point is higher than 200° C., the fluidity tends to lower. The softening point means the softening point measured on the basis of the ring and ball method in JIS-K-6911.

The blend amount of each of the epoxy resins represented by the general formulae (III) to (XXXIII) is preferably 30% or more by mass, more preferably 50% or more by mass, even more preferably 60% or more by mass of the total of the epoxy resins in order to exhibit performances thereof from the viewpoint of the individual viewpoints.

The curing agent (B) used in the invention is characterized by containing (C) a compound represented by the following general formula (I) wherein n is an integer of 1 to 10 and m is an integer of 1 to 10, which may be hereinafter referred to as the compound (C) represented by the following general formula (I):

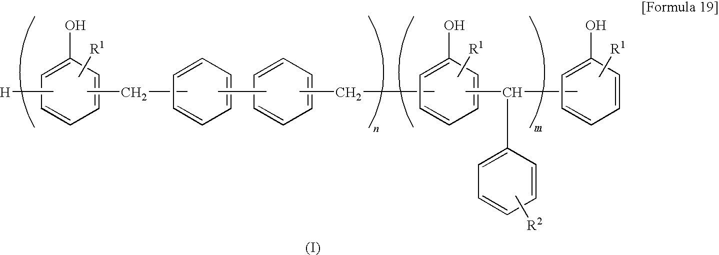

wherein R¹ is selected from a hydrogen atom, and substituted or unsubstituted monovalent hydrocarbon groups having 1 to 10 carbon atoms, and R² is selected from a hydrogen atom, and substituted or unsubstituted monovalent hydrocarbon groups having 1 to 10 carbon atoms.

Examples of the compound represented by the general formula (I) include a random copolymer containing the structural units the number of which is n, and the structural units the number of which is m at random, an alternating copolymer containing the units alternately, a copolymer containing the units regularly, and a block copolymer containing the units in the form of blocks. These may be used alone or in combination of two or more thereof.

The compound (C) represented by the general formula (I) is obtained by causing a phenol compound to react with an aromatic aldehyde and a biphenylene compound in the presence of an acidic catalyst.

The phenol compound may be phenol, or a substituted phenol such as cresol, ethylphenol or butylphenol. The aromatic aldehyde is an aromatic compound having an aldehyde group bonded to an aromatic species. Examples of the aromatic aldehyde include benzaldehyde, methylbenzaldehyde, ethylbenzaldehyde, and tert-butylbenzaldehyde.

Examples of the biphenylene compound include biphenylene glycol, biphenylene glycol dimethyl ether, biphenylene glycol diethyl ether, biphenylene glycol diacetoxy ester, biphenylene glycol dipropioxy ester, biphenylene glycol monomethyl ether, and biphenylene glycol monoacetoxy ester. Particularly preferred are biphenylene glycol and biphenylene glycol dimethyl ether.

A biphenylene compound represented by the following general formula (a) may be used:

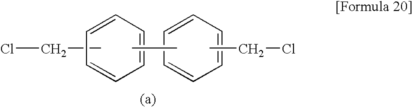

The ratio between m and n can be controlled by varying the charged amounts of the aromatic aldehyde and the biphenylene compound. An actual ratio between m and n can be checked on the basis of the average N of n's and the average M of m's by determining the ratio between methylene groups and methine groups in the resultant compounds quantitatively by ¹H-NMR and ¹³C-NMR. When the curing agent (B) contains at least the compound (C) represented by the general formula (I) wherein n is an integer of 1 to 10 and m is an integer of 1 to 10, the curing agent (B) may contain a compound of the general formula (I) wherein n and m are each a different value.

The ratio between the average N of n's and the average M of m's in the general formula (I) is preferably from 0.05 to 0.5, more preferably from 0.1 to 0.3 when the ratio is represented by the value of M/(N+M). When the ratio is 0.05 or more, the curability and the Tg are made high. When the ratio is 0.5 or less, the flame retardancy becomes good.

The compound (C) represented by the general formula (I) may be HE-610C manufactured by Air Water Inc., wherein R¹ and R² are each a hydrogen atom, or the like as an available product.

The blend amount of the compound (C) represented by the general formula (I) is not particularly limited as long as the advantageous effects of the invention can be obtained. The amount is preferably from 40 to 100% by mass, more preferably from 60 to 100% by mass of the total of the curing agent (B). If the amount is less than 40% by mass, the effect of flame retardancy tends to lower.

As another species of the curing agent (B), a curing agent known in the prior art may be used together in the resin composition of the invention. The curing agent that may be used together is not particularly limited as long as the agent is a curing agent that is ordinarily used in epoxy resin compositions for sealing. Examples thereof include a Novolak type phenol resin obtained by condensing or cocondensing a phenol compound such as phenol, cresol, resorcin, catechol, bisphenol A, bisphenol F, phenyphenol or aminophenol and/or a naphthol compound such as α-naphthol, β-naphthol or dihydroxynaphthol with a compound having an aldehyde group, such as formaldehyde, benzaldehyde or salicylaldehyde in the presence of an acidic catalyst; an aralkyl type phenol resin such as a phenol/aralkyl resin, a biphenylene type phenol/aralkyl resin, naphthol/aralkyl resin synthesized from a phenol compound and/or a naphthol compound, and dimethoxy-p-xylene or bis(methoxymethyl)biphenyl; a dicyclopentadiene type phenol Novolak resin synthesized by copolymerizing a phenol compound and/or a naphthol compound with dicyclopentadiene; a dicyclopentadiene type phenol resin such as dicyclopentadiene type naphthol Novolak resin; a triphenylmethane type phenol resin; a terpene modified phenol resin; a p-xylylene and/or m-xylylene modified phenol resin; a melamine modified phenol resin; a cyclopentadiene modified phenol resin; and a phenol resin obtained by copolymerizing two or more of these resins. These may be used alone or in combination of two or more thereof.

Of the resins, a phenol/aralkyl resin represented by the following general formula (XXXIV) is preferred from the viewpoint of flame retardancy and moldability:

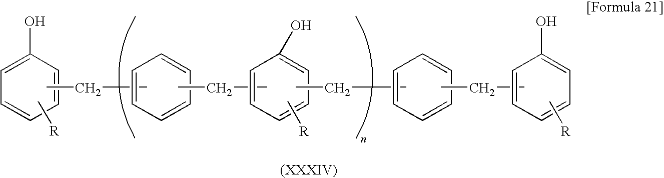

wherein R is selected from a hydrogen atom and a substituted or unsubstituted monovalent hydrocarbon group having 1 to 10 carbon atoms, and n represents an integer of 0 to 10.

More preferred is a phenol/aralkyl resin wherein R in the general formula (XXXIV) is a hydrogen atom and the average of n's is from 0 to 8. A specific example thereof is p-xylylene type phenol/aralkyl resin, or m-xylylene type phenol/aralkyl resin. Such a compound may be XLC (trade name) manufactured by Mitsui Chemicals, Inc. or the like as a commercially available product. In the case of using the aralkyl type phenol resin, the blend amount thereof is preferably 30% or more by mass, more preferably 50% or more by mass of the total of the curing agent species in order to exhibit the performance thereof.

The naphthol/aralkyl resin is, for example, a phenol resin represented by the following general formula (XXXV):

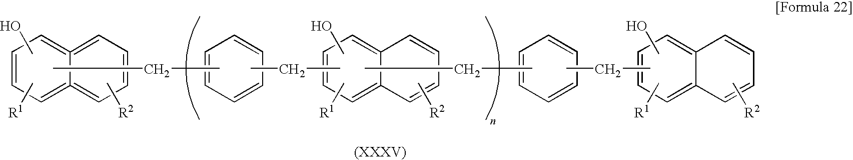

wherein R¹ and R² are selected from hydrogen atoms and substituted or unsubstituted monovalent hydrocarbon groups having 1 to 10 carbon atoms, and may wholly be the same or different, and n represents an integer of 0 to 10.

The naphthol/aralkyl resin represented by the general formula (XXXV) is, for example, a compound wherein R¹ and R² are each a hydrogen. Such a compound may be SN-170 (trade name) manufactured by Nippon Steel Chemical Co., Ltd. or the like as a commercially available product.

The dicyclopentadiene type phenol resin is, for example, a phenol resin represented by the following general formula (XXXVI):

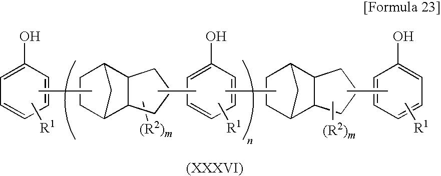

wherein R¹ and R² are each independently selected from a hydrogen atom and substituted or unsubstituted monovalent hydrocarbon groups having 1 to 10 carbon atoms, n represents an integer of 0 to 10, and m represents an integer of 0 to 6.

The above-mentioned compound wherein R¹ and R² are each a hydrogen atom may be DPP (trade name) manufactured by Nippon Petrochemicals Co., Ltd. or the like as a commercially available product.

The triphenylmethane type phenol resin is, for example, a phenol resin represented by the following general formula (XXXVII):

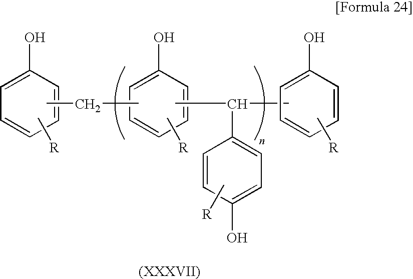

wherein R is selected from a hydrogen atom and substituted or unsubstituted monovalent hydrocarbon groups having 1 to 10 carbon atoms, and n represents an integer of 1 to 10.

The above-mentioned compound wherein R is a hydrogen atom may be MEH-7500 (tradename) manufactured by Meiwa Chemical Industry Co., Ltd. or the like as a commercially available product.

Examples of the Novolak type phenol resin include phenol Novolak resin, cresol Novolak resin, and naphthol Novolak resin. Of the resins, phenol Novolak is preferred.

The biphenylene type phenol/aralkyl resin is, for example, a biphenylene-skeleton-containing phenol/aralkyl resin represented by the following general formula (XXXVIII):

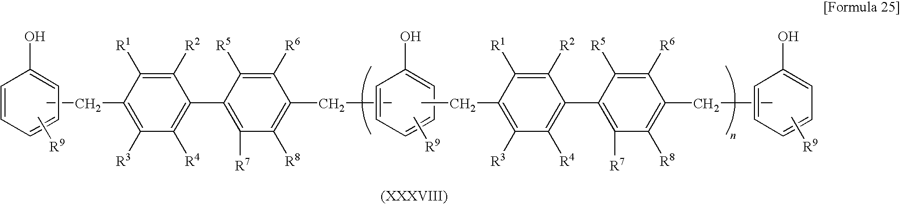

wherein R¹ to R⁹ may wholly be the same or different, and are selected from hydrogen atoms, alkyl groups having 1 to 10 carbon atoms, such as methyl, ethyl, propyl, butyl, isopropyl and isobutyl groups, alkoxyl groups having 1 to 10 carbon atoms, such as methoxy, ethoxy, propoxy and butoxy groups, aryl groups having 6 to 10 carbon atoms, such as phenyl, tolyl and xylyl groups, and aralkyl groups having 6 to 10 carbon atoms, such as benzyl and phenethyl groups. Of the examples, a hydrogen atom and a methyl group are preferred. n represents an integer of 0 to 10.

The biphenylene type phenol/aralkyl resin represented by the general formula (XXXVIII) is, for example, a compound wherein R¹ to R⁹ are each a hydrogen atom. From the viewpoint of melt viscosity, preferred is a mixture of condensates containing 50% or more by mass of a condensate wherein n is 1 or more.

Such a compound may be MEH-7851 (manufactured by Meiwa Chemical Industry Co., Ltd.) or the like as a commercially available product.

The above-mentioned phenol/aralkyl resin, naphthol/aralkyl resin, dicyclopentadiene type phenol resin, triphenylmethane type phenol resin, Novolak type phenol resin, and biphenylene type phenol/aralkyl resin may be used alone or in combination of two or more thereof.

Of the above-mentioned phenol resins, which are each used together, in particular, the Novolak type phenol resin is preferred from the viewpoint of curability, and the phenol/aralkyl resin, the naphthol/aralkyl resin, biphenylene type phenol/aralkyl resin and other aralkyl type phenol resins are preferred from the viewpoint of fluidity and reflow resistance.

The epoxy resin composition of the invention for sealing may contain acenaphthylene in order to improve the flame retardancy thereof. Acenaphthylene can be obtained by dehydrogenating acenaphthene; however, a commercially available product thereof may be used. It is allowable to use acenaphthylene in the form of a polymer made from acenaphthylene, or a copolymer made from acenaphthylene and a different aromatic olefin. Examples of the method for yielding the acenaphthylene polymer or the acenaphthylene/different-aromatic-olefin copolymer include radical polymerization, cationic polymerization, and anionic polymerization. In the polymerization, a catalyst known in the prior art can be used; however, the polymerization can be conducted only by heat without using any catalyst. At this time, the polymerizing temperature is preferably from 80 to 160° C., more preferably from 90 to 150° C. The softening point of the resultant acenaphthylene polymer or the acenaphthylene/different-aromatic-olefin copolymer is preferably from 60 to 150° C., more preferably from 70 to 130° C. If the softening point is lower than 60° C., the moldability tends to lower by an ooze thereof when the composition is molded. If the softening point is higher than 150° C., the compatibility with the resin tends to decline.

Examples of the different aromatic olefin, which is copolymerized with acenaphthylene, include styrene, α-methylstyrene, indene, benzothiophene, benzofurane, vinylnaphthalene, vinylbiphenyl, and alkyl-substituted products thereof. Besides the aromatic olefin, an aliphatic olefin may be used together as long as the advantageous effects of the invention are not damaged. Examples of the aliphatic olefin include (meth)acrylic acid and esters thereof; and maleic anhydride, itaconic anhydride and fumaric acid, and esters thereof. The use amount of the aliphatic olefin is not particularly limited, and is preferably 20% or less by mass of the total of the polymerizable monomers, more preferably 9% or less by mass thereof.

Acenaphthylene may be preliminarily mixed with a part or the whole of the curing agent (B). It is allowable to use a product wherein a part or the whole of the curing agent (B) is preliminarily mixed with at least one of acenaphthylene, the acenaphthylene polymer and the acenaphthylene/different-aromatic-olefin copolymer, which may be referred to as an acenaphthylene component hereinafter. The method for the preliminary mixing is a method of pulverizing each of the component (B) and the acenaphthylene component finely, and mixing the resultants, which are in a solid state, as they are by means of a mixer or the like; a method of dissolving these components evenly into a solvent wherein the components can be dissolved, and then removing the solvent; a method of melting the component (B) and the acenaphthylene component at a temperature not lower than the softening point(s) of the component (B) and/or the acenaphthylene component, and mixing them; or some other method. Of the methods, preferred is the melt-mixing method, in which a homogeneous mixture can be obtained and the amount of incorporated impurities is small. The temperature at the time of the melt-mixing is not limited as long as the temperature is a temperature not lower than the softening point (s) of the component (B) and/or the acenaphthylene component. The temperature is preferably from 100 to 250° C., more preferably from 120 to 200° C. The mixing time for the melt-mixing is not limited as long as the above-mentioned components are evenly mixed. The time is preferably from 1 to 20 hours, more preferably from 2 to 15 hours.

When the curing agent (B) is preliminarily mixed with the acenaphthylene component, the acenaphthylene component may be polymerized or may be caused to react with the curing agent (B) during the mixing. In the epoxy resin composition of the invention for sealing, it is preferred that the curing agent (B) contains therein the preliminary mixture (acenaphthylene-modified curing agent) in an amount of 90% or more by mass from the viewpoint of an improvement in the flame retardancy, which results from the dispersibility of the acenaphthylene component.

The amount of the acenaphthylene component contained in the acenaphthylene-modified curing agent is not particularly limited, and is preferably from 5 to 40% by mass, more preferably from 8 to 25% by mass. If the amount is less than 5% by mass, the effect of improving the flame retardancy tends to decline. If the amount is more than 40% by mass, the moldability tends to decline. The content by percentage of the acenaphthylene component contained in the epoxy resin composition of the invention is not particularly limited, and is preferably from 0.1 to 5% by mass, more preferably from 0.3 to 3% by mass from the viewpoint of flame retardancy and moldability. If the content by percentage is less than 0.1% by mass, the flame retardancy effect tends to decline. If the content by percentage is more than 5% by mass, the moldability tends to decline.

The ratio by equivalent between the epoxy resin (A) and the curing agent (B), that is, the ratio of the number of hydroxyl groups in the curing agents to the number of epoxy groups in the epoxy resin (the number of hydroxyl groups in the curing agents/the number of epoxy groups in the epoxy resin) is not particularly limited. The ratio is set preferably into the range of 0.5 to 2, more preferably into the range of 0.6 to 1.3 to control the unreacted amount of each of the components into a small amount. The ratio is set even more preferably into the range of 0.8 to 1.2 to obtain the epoxy resin composition for sealing which is excellent in moldability and reflow resistance.

In the epoxy resin composition of the invention for sealing, (D) a curing promoter may be optionally used in order to promote the reaction between the epoxy resin (A) and the curing agent (B).

The curing promoter (D) is not particularly limited as long as the promoter is a curing promoter that is ordinarily used in epoxy resin compositions for sealing. Examples thereof include cycloamidine compounds such as 1,8-diazabicyclo (5,4,0) undecene-7, 1,5-diazabicyclo(4,3,0)nonene and 5,6-dibutylamino-1,8-diazabicyclo(5,4,0)undecene-7, and compounds which have intermolecular polarity and are obtained by adding, to the compounds, a compound having a π bond, such as maleic anhydride, a quinone compound such as 1,4-benzoquinone, 2,5-toluquinone, 1,4-naphthoquinone, 2,3-dimethylbenzoquinone, 2,6-dimethylbenzoquinone, 2,3-dimethoxy-5-methyl-1,4-benzoquinone, 2,3-dimethoxy-1,4-benzoquinone or phenyl-1,4-benzoquinone, diazophenylmethane, or phenol resin;

tertiary amines and derivatives thereof, such as benzyldimethylamine, triethanolamine, dimethylaminoethanol and tris(dimethylaminomethyl)phenol;

imidazoles and derivatives thereof, such as 2-methylimidazole, 2-phenylimidazole and 2-phenyl-4-methylimidzole;

phosphine compounds, such as tributylphosphine, methyldiphenylphosphine, triphenylphosphine, tris(4-methylphenyl)phosphine, diphenylphosphine and phenylphosphine, and phosphorus compounds which have intermolecular polarity and are obtained by adding, to the compounds, a compound having a π bond such as maleic anhydride, any one of the above-mentioned quinone compounds, diazophenylmethane, or phenol resin;

tetraphenyl borates and derivatives thereof, such as tetraphenylphosphonium tetraphenyl borate, triphenylphosphine tetraphenyl borate, 2-ethyl-4-methylimidazole tetraphenyl borate and N-methylmorpholine tetraphenyl borate. These may be used alone or in combination of two or more thereof.

Of the curing promoters, triphenylphosphine is preferred from the viewpoint of flame retardancy and curability, and an adduct of a phosphine compound and a quinone compound, in particular, an adduct of a tertiary phosphine compound and a quinone compound is preferred from the viewpoint of flame retardancy, curability, fluidity, and releasability. The tertiary phosphine compound is not particularly limited, and is preferably a phosphine compound having an alkyl group or aryl group, such as tricyclohexylphosphine, tributylphosphine, dibutylphenylphosphine, butyldiphenylphosphine, ethyldiphenylphosphine, triphenylphosphine, tris(4-methylphenyl)phosphine, tris(4-ethylphenyl)phosphine, tris(4-propylphenyl)phosphine, tris(4-butylphenyl)phosphine, tris(isopropylphenyl)phosphine, tris(tert-butylphenyl)phosphine, tris(2,4-dimethylphenyl)phosphine, tris(2,6-dimethylphenyl)phosphine, tris(2,4,6-trimethylphenyl)phosphine, tris(2,6-dimethyl-4-ethoxyphenyl)phosphine, tris(4-methoxyphen yl)phosphine, or tris (4-ethoxyphenyl)phosphine. Examples of the quinone compound include o-benzoquinone, p-benzoquinone, diphenoquinone, 1,4-naphthoquinone and anthraquinone. Of the quinones, p-benzoquinone is preferred from the viewpoint of humidity resistance and storage stability. More preferred is an adduct of tris(4-methylphenyl)phosphine and p-benzoquinone from the viewpoint of releasability.

The blend amount of the curing promoter (D) is not particularly limited as the amount is an amount for attaining the effect of the curing promotion. The amount is preferably from 0.005 to 2% by mass of the epoxy resin composition for sealing, more preferably from 0.01 to 0.5% by mass thereof. If the amount is less than 0.005%, the curability in a short time tends to be poor. If the amount is more than 2% by mass, the curing speed is too large so that a good molded product tends not to be easily obtained.

If necessary, (E) an inorganic filler may be incorporated into the invention. The inorganic filler has hygroscopicity, and effects of decreasing the linear expansion coefficient, and improving the thermal conductivity and the strength. Examples thereof include fused silica, crystalline silica, alumina, zircon, calcium silicate, calcium carbonate, potassium titanate, silicon carbide, siliconnitride, aluminumnitride, boronnitride, beryllia, zirconia, zircon, forsterite, steatite, spinel, mullite and titania powders; beads obtained by making these powders into spheres; and glass fiber. Examples of the inorganic filler which has a flame retardant effect include aluminum hydroxide, magnesium hydroxide, composite metal hydroxides, zinc borate, and zinc molybdate. Zinc borate may be FB-290 or FB-500 (manufactured by U.S. Borax Co.), FRZ-500C (manufactured by Mizusawa Industrial Chemicals, Ltd.) or like as a commercially available product, and zinc molybdate may be KEMGARD911B, 911C or 1100 (manufactured by Sherwin-Williams Co.) or the like as a commercially available product.

These inorganic fillers may be used alone or in combination of two or more. From the viewpoint of filling performance and a decrease in the linear expansion coefficient, fused silica is preferred, and from the viewpoint of high thermal conductivity, alumina is preferred. The form of the inorganic filler is preferably spherical from the viewpoint of filling performance and mold-abrasion resistance.

The blend amount of the inorganic filler is not particularly limited, and is preferably 50% or more by mass of the epoxy resin composition for sealing from the viewpoint of flame retardancy, moldability, hygroscopicity, a decrease in the linear expansion coefficient, an improvement in the strength, and reflow resistance, and is more preferably from 60 to 95% by mass, even more preferably from 70 to 90% by mass thereof from the viewpoint of flame retardancy. If the amount is less than 60% by mass, the flame-retardancy- and reflow-resistance-improving effects tend to lower. If the amount is more than 95% by mass, the fluidity tends to be insufficient and the flame retardancy also tends to lower.

When the inorganic filler (E) is used, it is preferred that (F) a coupling agent is further incorporated into the epoxy resin composition of the invention for sealing in order to improve the adhesiveness between the resin components and the filler. The coupling agent (F) is not particularly limited as long as the agent is an agent that is ordinarily used in epoxy resin compositions for sealing. Examples thereof include silane compounds having one or more primary and/or secondary and/or tertiary amino groups, epoxy silanes, mercaptosilanes, alkylsilanes, ureidosilanes, vinysilanes and other various silane compounds, titanium based compounds, aluminum chelates, and aluminum/zirconium compounds.

Examples thereof include silane coupling agents such as vinyltrichlorosilane, vinyltriethoxysilane, vinyltris(β-methoxyethoxy)silane, γ-methacryloxypropyltrimethoxysilane, β-(3,4-epoxycyclohexyl)ethyltrimethoxysilane, γ-glycidoxypropyltrimethoxysilane, γ-glycidoxypropylmethyldimethoxysilane, vinyltriacetoxysilane, γ-mercaptopropyltrimethoxysilane, γ-aminopropyltrimethoxysilane, γ-aminopropyldimethoxysilane, γ-aminopropyltriethoxysilane, γ-aminopropylmethyldiethoxysilane, γ-anilinopropyltrimethoxysilane, γ-anilinopropyltriethoxysilane, γ-(N,N-dimethyl)aminopropyltrimethoxysilane, γ-(N,N-diethyl)aminopropyltrimethoxysilane, γ-(N,N-dibutyl)aminopropyltrimethoxysilane, γ-(N-methyl)anilinopropyltrimethoxysilane, γ-(N-ethyl)anilinopropyltrimethoxysilane, γ-(N,N-dimethyl)aminopropyltriethoxysilane, γ-(N,N-diethyl)aminopropyltriethoxysilane, γ-(N,N-dibutyl)aminopropyltriethoxysilane, γ-(N-methyl)anilinopropyltriethoxysilane, γ-(N-ethyl)anilinopropyltriethoxysilane, γ-(N,N-dimethyl)aminopropylmethyldimethoxysilane, γ-(N,N-diethyl)aminopropylmethyldimethoxysilane, γ-(N,N-dibutyl)aminopropylmethyldimethoxysilane, γ-(N-methyl)anilinopropylmethyldimethoxysilane, γ-(N-ethyl)anilinopropylmethyldimethoxysilane, N-(trimethoxysilylpropyl)ethylenediamine, N-(dimethoxymethylsilylisopropyl)ethylenediamine, methyltrimethoxysilane, dimethyldimethoxysialne, methyltriethoxysilane, γ-chloropropyltrimethoxysilane, hexamethyldisilane, vinyltrimethoxysilane, and γ-mercaptopropylmethyldimethoxysilane; and

titanium based coupling agents such as isopropyltriisostearoyl titanate, isopropyltris(dioctylpyrophosphate) titanate, isopropyltri(N-aminoethyl-aminoethyl) titanate, tetraoctylbis(ditridecylphosphate) titanate, tetra(2,2-diallyloxymethyl-1-butyl)bis(ditridecyl)phosphate titanate, bis(dioctylpyrophosphate) oxyacetatetitanate, bis(dioctylpyrophosphate) ethylenetitanate, isopropyltrioctanoyl titanate, isopropyldimethacryloylisostearoyl titanate, isopropyltridecylbenzenesulfonyl titanate, isopropylisostearoyldiacryl titanate, isopropyltri(dioctylphosphate) titanate, isopropyltricumylphenyl titanate, and tetraisopropylbis(dioctylphosphate) titanate. These may be used alone or in combination of two or more thereof.

The resin composition preferably contains, out of these agents, a silane coupling agent having a secondary amino group. The silane coupling agent having a secondary amino group is not particularly limited as long as the agent is a silane compound having, in the molecule thereof, a secondary amino group. Examples thereof include γ-anilinopropyltrimethoxysilane, γ-anilinopropyltriethoxysilane, γ-anilinopropylmethyldimethoxysilane, γ-anilinopropylmethyldiethoxysilane, γ-anilinopropylethyldiethoxysilane, γ-anilinopropylethyldimethoxysilane, γ-anilinomethyltrimethoxysilane, γ-anilinomethyltriethoxysilane, γ-anilinomethylmethyldimethoxysilane, γ-anilinomethylmethyldiethoxysilane, γ-anilinomethylethyldiethoxysilane, γ-anilinomethylethyldimethoxysilane, N-(p-methoxyphenyl)-γ-aminopropyltrimethoxysilane, N-(p-methoxyphenyl)-γ-aminopropyltriethoxysilane, N-(p-methoxyphenyl)-γ-aminopropylmethyldimethoxysilane, N-(p-methoxyphenyl)-γ-aminopropylmethyldiethoxysilane, N-(p-methoxyphenyl)-γ-aminopropylethyldiethoxysilane, N-(p-methoxyphenyl)-γ-aminopropylethyldimethoxysilane, γ-(N-methyl)aminopropyltrimethoxysilane, γ-(N-ethyl)aminopropyltrimethoxysilane, γ-(N-butyl)aminopropyltrimethoxysilane, γ-(N-benzyl)aminopropyltrimethoxysilane, γ-(N-methyl)aminopropyltriethoxysilane, γ-(N-ethyl)aminopropyltriethoxysilane, γ-(N-butyl)aminopropyltriethoxysilane, γ-(N-benzyl)aminopropyltriethoxysilane, γ-(N-methyl)aminopropylmethyldimethoxysilane, γ-(N-ethyl)aminopropylmethyldimethoxysilane, γ-(N-butyl)aminopropylmethyldimethoxysilane, γ-(N-benzyl)aminopropylmethyldimethoxysilane, N-β-(aminoethyl)-γ-aminopropyltrimethoxysialne, γ-(β-aminoethyl)aminopropyltrimethoxysilane, and N-β-(N-vinylbenzylaminoethyl)-γ-aminopropyltrimethoxysilane.

The resin composition in particular preferably contains an aminosilane coupling agent represented by the following general formula (II):

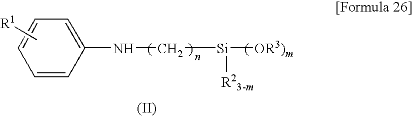

wherein R¹ is selected from a hydrogen atom, alkyl groups having 1 to 6 carbon atoms, and alkoxy groups having 1 to 2 carbon atoms, R² is selected from alkyl groups having 1 to 6 carbon atoms, and a phenyl group, R³ represents a methyl or ethyl group, n represents an integer of 1 to 6, and m represents an integer of 1 to 3.

The total amount of the coupling agent (s) is preferably from 0.037 to 5.0% by mass, more preferably from 0.05 to 4.75% by mass, even more preferably from 0.1 to 2.5% by mass of the epoxy resin composition for sealing. If the amount is less than 0.037% by mass, the effect of improving the adhesiveness to a frame tends to lower. If the amount is more than 5.0% by mass, the moldability of the package tends to lower.

A halogen-free and antimony-free flame retardant known in the prior art may be optionally incorporated into the epoxy resin composition of the invention for sealing to improve the flame retardancy further. Examples thereof include red phosphorus, red phosphorus coated with an inorganic compound such as zinc oxide and a thermosetting resin such as phenol resin, and phosphorus compounds such as a phosphate and phosphine oxide; nitrogen-containing compounds such as melamine, melamine derivatives, melamine-modified phenol resin, compounds having a triazine ring, cyanuric acid derivatives, and isocyanuric acid derivatives; phosphorus- and nitrogen-containing compounds such as cyclophosphazene; and metal-element-containing compounds such as aluminum hydroxide, magnesium hydroxide, composite metal hydroxides, zinc oxide, zinc stannate, zinc borate, iron oxide, molybdenum oxide, zinc molybdate, and dicyclopentadienyliron. These may be used alone or in combination of two or more thereof.

Of the flame retardants, preferred are a phosphate, phosphine oxide and cyclophosphazene from the viewpoint of fluidity. The phosphate is not particularly limited as long as the phosphate is an ester compound made from phosphoric acid, and an alcohol compound or phenol compound. Examples thereof include trimethyl phosphate, triethyl phosphate, triphenyl phosphate, tricresyl phosphate, trixylenyl phosphate, cresyldiphenyl phosphate, xylenyldiphenyl phosphate, tris(2,6-dimethylphenyl) phosphate, and aromatic condensed phosphates. Of the phosphates, preferred is an aromatic condensed phosphate represented by the general formula (XXXIX) from the viewpoint of hydrolysis resistance:

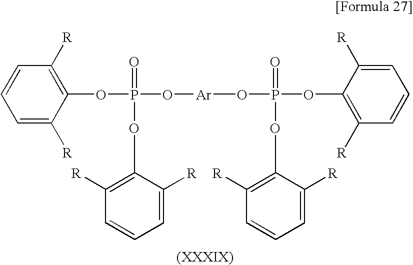

wherein Rs each represents an alkyl having 1 to 4, and Rs may wholly be the same or different, and Ar represents an aromatic ring.

Examples of the phosphate of the formula (XXXIX) include phosphates represented by the following structural formulae (XXXX) to (XXXXIV):

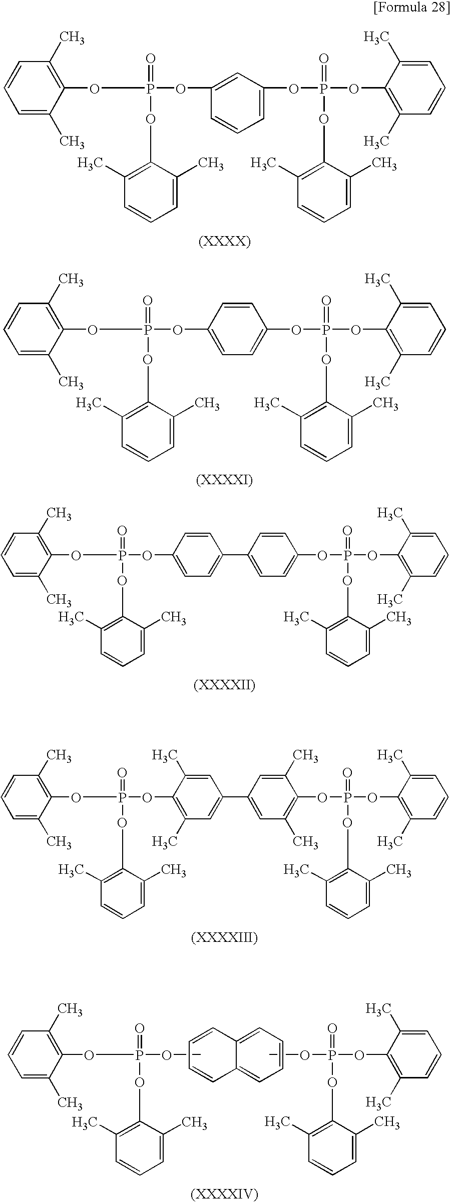

The addition amount of the phosphate is not particularly limited, and the amount is, as the amount of phosphorus atoms therein, preferably from 0.2 to 3.0% by mass of all the blend components other than the filler. If the amount is less than 0.2% by mass, the flame retardant effect tends to lower. If the amount is more than 3.0% by mass, the moldability or the humidity resistance may lower, or when the composition is molded, the phosphate may ooze to damage the external appearance.

When the phosphine oxide is used as a flame retardant, the phosphine oxide is preferably a compound represented by the general formula (XXXXV):

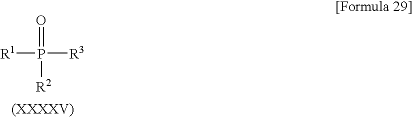

wherein R¹, R² and R³ each represent a substituted or unsubstituted alkyl group having 1 to 10 carbon atoms, an aryl group, an aralkyl group, and a hydrogen atom, and may wholly be the same or different provided that a case where R¹, R² and R³ are each a hydrogen atom is excluded.

Of species of the phosphorus compound represented by the general formula (XXXXV), preferred is a compound wherein R¹ to R³ are each a substituted or unsubstituted aryl group, and particularly preferred is a compound wherein they are each a phenyl group from the viewpoint of hydrolysis resistance.

The blend amount of the phosphine oxide is not particularly limited, and the amount is, as the amount of phosphorus atoms therein, preferably from 0.01 to 0.2% by mass, more preferably from 0.02 to 0.1% by mass, even more preferably from 0.03 to 0.08% by mass of the epoxy resin composition for sealing. If the amount is less than 0.01% by mass, the flame retardant effect tends to lower. If the amount is more than 0.2% by mass, the moldability or the humidity resistance tends to lower.

The cyclophosphazene may be a cyclic phosphazene compound having, in the main chain skeleton thereof, a formula (XXXXVI) illustrated below and/or a formula (XXXXVII) illustrated below as one or more recurring units; a compound containing, as one or more recurring units, a formula (XXXXVIII) illustrated below and/or a formula (XXXXIX) illustrated below, wherein the positions of substituents on the phosphorus atoms in a phosphazene ring are different; or some other compound.

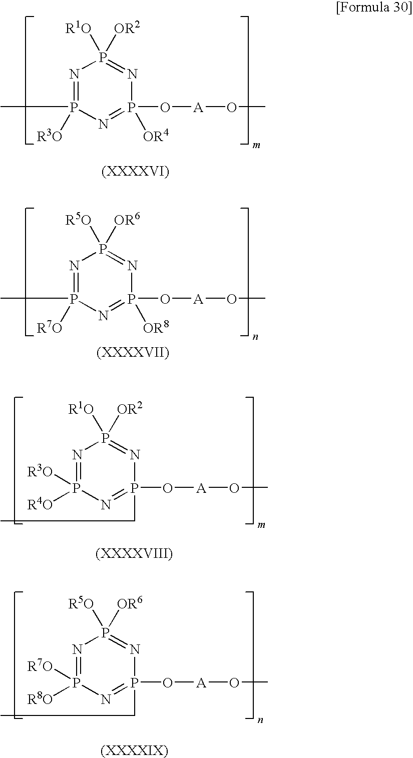

In the formulae (XXXXVI) and (XXXVIII), m is an integer of 1 to 10, and any R¹ to any R⁴ are selected from alkyl groups which have 1 to 12 carbon atoms and may have a substituent, and aryl groups which may have a substituent, and may wholly be the same or different; and any A represents an alkylene group having 1 to 4 carbon atoms, or a bivalent hydrocarbon group containing an aromatic ring. In the formulae (XXXXVII) and (XXXXIX), n is an integer of 1 to 10, and any R⁵ and any R⁸ are selected from alkyl groups which have 1 to 12 carbon atoms and may have a substituent or aryl groups which may have a substituent, and may wholly be the same or different; and any A represents an alkylene group having 1 to 4 carbon atoms, or a bivalent hydrocarbon group containing an aromatic ring.

In the formulae, R's, the number of which is m, may wholly be the same or different; the same matter is applied to R²s, R³s and R⁴s. R⁵s, the number of which is n, may wholly be the same or different; the same matter is applied to R⁶s, R⁷s and R⁸s.

The alkyl groups having 1 to 12 carbon atoms or the aryl groups represented by R¹s to R⁸s in the formulae (XXXXVI) to (XXXXIX), which may each have a substituent, are not particularly limited, and examples thereof include alkyl groups such as methyl, ethyl, propyl, isopropyl, butyl, isobutyl, sec-butyl, and tert-butyl groups; aryl groups such as phenyl, 1-naphthyl and 2-naphthyl groups; alkyl-group-substituted aryl groups such as o-tolyl, m-tolyl, p-tolyl, 2,3-xylyl, 2,4-xylyl o-cumenyl, m-cumenyl, p-cumenyl, and mesityl groups; and aryl-group-substituted alkyl groups such as benzyl and phenethyl groups. Examples of the substituent with which these groups are substituted include alkyl, alkoxyl, aryl, hydroxyl, amino, epoxy, vinyl, hydroxyalkyl and alkylamino groups.

Of these groups, aryl groups are preferred and a phenyl or hydroxyphenyl group is more preferred from the viewpoint of the heat resistance and humidity resistance of the epoxy resin composition.

The alkylene having 1 to 4 carbon atoms or the aromatic-ring-containing bivalent hydrocarbon group represented by A in the formulae (XXXXVI) to (XXXXIX) is not particularly limited, and examples thereof include alkylene groups such as methylene, ethylene, propylene, isopropylene, butylene and isobutylene groups, arylene groups such as phenylene, tolylene and naphthylene groups, and a xylylene group. From the viewpoint of the heat resistance and humidity resistance of the epoxy resin composition, arylene groups are preferred and a phenylene group is more preferred.

The cyclic phosphazene compound is, for example, a polymer from any one of the formula (XXXXVI) to the formula (XXXXIX), a copolymer of the formula (XXXXVI) and the formula (XXXXVII), or a copolymer of the formula (XXXXVIII) and the formula (XXXXIX). In the case of the copolymer, the copolymer may a random copolymer, a block copolymer, or an alternating copolymer. The copolymerization mole ratio m/n is not particularly limited, and is preferably from 1/0 to 1/4, more preferably from 1/0 to 1/1.5 from the viewpoint of an improvement in the heat resistance and the strength of the epoxy resin cured product. The polymerization degree m+n of the polymer or the copolymer is from 1 to 20, preferably from 2 to 8, more preferably from 3 to 6.

Preferred examples of the cyclic phosphazene compound include a polymer of the following formula (XXXXX) and a copolymer of the following formula (XXXXXI):

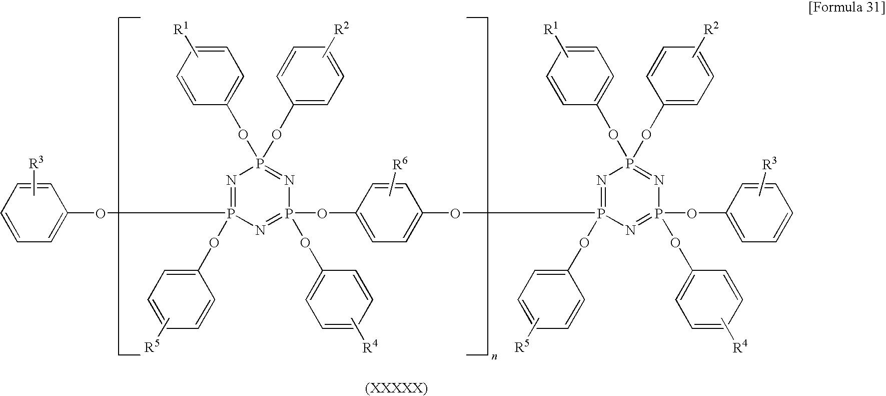

wherein n is an integer of 0 to 9, and R¹ to R⁶ each independently represent a hydrogen atom or a hydroxyl group, and

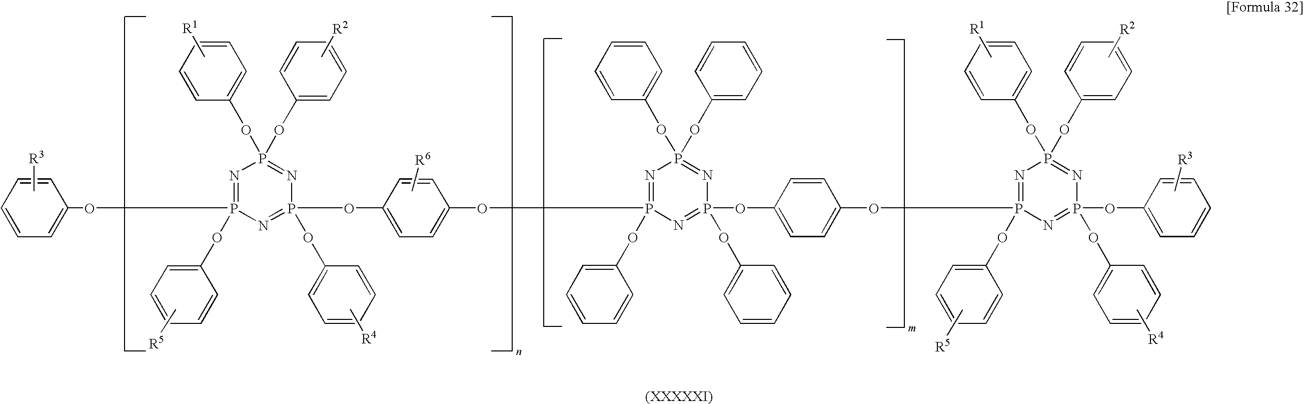

wherein m and n are each an integer of 0 to 9, and R¹ to R⁶ are each independently selected from a hydrogen atom or a hydroxyl group. The cyclic phosphazene compound represented by the formula (XXXXXI) may be any one of a compound containing recurring units (a) each illustrated below, the number of which is n, and recurring unit (b) each illustrated below, the number of which is m, alternately, a compound containing the same in a block form, and a compound containing the same at random. The compound containing the same at random is preferred. In the formula (a), R¹, R² and R⁴ to R⁶ are each common to the corresponding one in the formula (XXXXXI).

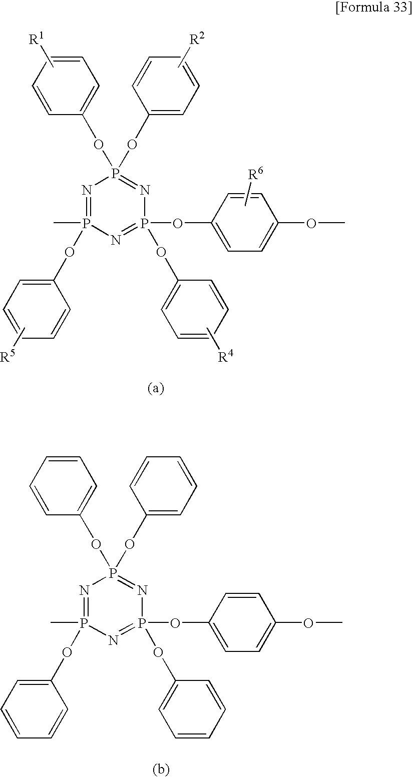

Of the examples, preferred is a product made mainly of polymers wherein n in the formula (XXXXX) is from 3 to 6 or a product made mainly of copolymers wherein R¹ to R⁶ in the formula (XXXXXI) are each a hydrogen atom or one of R¹ to R⁶ is a hydroxyl group, the ratio m/n is from 1/2 to 1/3, and m+n is from 3 to 6. As a commercially available phosphazene compound, SPE-100 (trade name) manufactured by Ohtsuka Chemical Industrial Co., Ltd. can be obtained.

In the case of using, as the flame retardant, a composite metal hydroxide, the composite metal hydroxide is preferably a compound represented by the following composition formula (XXXXXII):

p(Mₐ¹O_{b}).q(M_{c}²O_{d}).r(Mₑ³O^{f}).mH₂O [Formula 34]

(XXXXXII)

wherein M¹, M² and M³ represent metal elements different from each other, a, b, c, d, e, f, p, q and m each represents a positive number, and r represents 0 or a positive number.

of Species of the Compound, Preferred is a Compound Wherein r in the composition formula (XXXXXII) is 0, that is, a compound represented by the following composition formula (XXXXXIII):

m(Mₐ¹O_{b}).n(M_{c}²O_{d}).lH₂O [Formula 35]

(XXXXXIII)

wherein M¹ and M² represent metal elements different from each other, a, b, c, d, e, m, n and l each represent a positive number. In the composition formulae (XXXXXII) and (XXXXXIII), M¹, M² and M³ are not particularly limited as long as M¹, M² and M³ are metal elements different from each other. From the viewpoint of flame retardancy, in order not to make M¹ and M² equal to each other, it is preferred that M¹ is selected from metal elements in the third period, alkaline earth metals in the IIA group, and metal elements belonging to the groups IVB, IIB, VIII, IB, IIIA and IVA, and M² is selected from transition metal elements in the groups IIIB to IIB. It is more preferred that M¹ is selected from magnesium, calcium, aluminum, tin, titanium, iron, cobalt, nickel, copper and zinc, and M² is selected from iron, cobalt, nickel, copper and zinc. From the viewpoint of fluidity, it is preferred that M¹ is magnesium and M² is zinc or nickel, and it is more preferred that M¹ is magnesium and M² is zinc.

The mole ratio between p, q and r in the composition formula (XXXXXII) is not particularly limited as long as the advantageous effects of the invention can be obtained. Preferably, r is 0, and the mole ratio between p and q, p/q, is from 99/1 to 50/50. In other words, the ratio between m and n in the composition formula (XXXXXIII), m/n, is preferably from 99/1 to 50/50.

A commercially available product thereof which can be used is, for example, a magnesium hydroxide/zinc hydroxide solid solution composite metal hydroxide wherein M¹ and M² in the composition formula (XXXXXIII) are magnesium and zinc, respectively, and m, n and l are 7, 3 and 10, respectively, and a, b, c and d are each 1 (tradename: ECHO MAG Z-10, manufactured by Tateho Chemical Industries Co., Ltd.). The metal elements may each be a semi-metal element, and mean all elements other than non-metal elements.

The classification of the metal elements is made on the basis of the long form of the periodic table, wherein typical elements and transition elements are grouped into subgroup A and subgroup B, respectively (source: “Kagaku Dai-Jiten 4” (“Dictionary of Chemistry 4”), 26^{th} impression of reduced-size edition on Oct. 15, 1981, published by Kyoritsu Shuppan Co., Ltd.).

The form of the composite metal hydroxide is not particularly limited, and is preferably the form of a polyhedron having an appropriate thickness rather than a tabular form. About the composite metal hydroxide, a polyhedral crystal is more easily obtained than about metal hydroxides.

The blend amount of the composite metal hydroxide is not particularly limited, and is preferably from 0.5 to 20% by mass, more preferably from 0.7 to 15% by mass, even more preferably from 1.4 to 12% by mass of the epoxy resin composition for sealing. If the amount is less than 0.5% by mass, the flame retardancy improving effect tends to lower. If the amount is more than 20% by mass, the fluidity and the reflow resistance tend to lower.

The compounds having a triazine ring, which are each used as the flame retardant, are preferably compounds each obtained by cocondensing a compound (a) having a phenolic hydroxyl group, a triazine derivative (b) and a compound (c) having an aldehyde group from the viewpoint of flame retardancy and adhesiveness to a copper frame. Examples of the phenolic-hydroxyl-group-having compound (a) include phenol, alkyl phenols such as cresol, xylenol, ethylphenol, butylphenol, nonylphenyl and octylphenol, polyhydric phenols such as resorcin, catechol, bisphenol A, bisphenol F and bisphenol S, phenylphenol, aminophenol, and naphthols such as α-naphthol, β-naphthol and dihydroxynaphthalene; and resins each obtained by condensing or cocondensing one or more of these compounds, which have a phenolic hydroxyl group, with a compound having an aldehyde group, such as formaldehyde, in the presence of an acidic catalyst. Of the examples, preferred is phenol or cresol, or a condensation copolymer made from the phenolic compound and formaldehyde from the viewpoint of moldability. The triazine derivative is not particularly limited as long as the derivative is a compound having, in the molecule thereof, a triazine nucleus. Examples thereof include melamine, guanamine derivatives such as benzoguanamine and acetoguanamine, cyanuric acid, and cyanuric acid derivatives such as methyl cyanurate. These may be used alone or in combination of two or more thereof. Of the examples, preferred are melamine, and guanamine derivatives such as benzoguanamine from the viewpoint of moldability and reliability. The aldehyde-group-having compound is, for example, formalin, or paraformaldehyde.

The amount of the aldehyde-group-having compound blended with the phenolic-hydroxyl-group-having compound is decided to set the mole ratio ((the mole number of) the aldehyde-group-having compound/((the mole number of) the phenolic-hydroxyl-group-having compound) preferably into the range of 0.05 to 0.9, more preferably into the range of 0.1 to 0.8. If the mole ratio is less than 0.05, the reaction of the aldehyde-group-having compound with the phenolic hydroxyl groups is not easily caused so that an unreacted fraction of the phenol remains easily. Thus, the productivity is poor. If the mole ratio is more than 0.9, gelation is easily caused in the synthesis.

The blend amount of the triazine derivative relative to the phenolic-hydroxyl-group-having compound is not particularly limited, and is preferably from 1 to 30% by mass, more preferably from 5 to 20% by mass. If the amount is less than 1% by mass, the flame retardancy is poor. If the amount is more than 30% by mass, the softening point becomes high; accordingly, when the composition is produced, the kneading performance lowers. The blend amount of the aldehyde-group-having compound relative to the triazine derivative (the mole ratio) is not particularly limited.

The reaction temperature in the synthesis of the condensation copolymer from the phenolic-hydroxyl-group-having compound, the triazine derivative and the aldehyde-group-having compound is not particularly limited, and is preferably from 60 to 120° C. The pH in the reaction is preferably from 3 to 9, more preferably from 4 to 8. If the pH is less than 3, the resin gelatinizes easily in the synthesis. If the pH is more than 9, there is not easily caused condensation copolymerization of the phenolic-hydroxyl-group-having compound, the triazine derivative and the aldehyde-group-having compound. Thus, the nitrogen content by percentage in the produced resin lowers.

After the phenolic-hydroxyl-group-having compound is caused to react with the aldehyde-group-having compound and the triazine derivative, unreacted fractions of the phenolic-hydroxyl-group-having compound and the aldehyde-group-having compound, and others can be removed by heating distillation or the like under a normal or reduced pressure if necessary. At this time, the remaining amount of the unreacted fraction of the phenolic-hydroxyl-group-having compound is preferably 3% or less. If the amount is more than 3%, the moldability is liable to lower.

The softening point of the resultant condensation copolymer is from 40 to 150° C. If the point is lower than 40° C., the copolymer easily undergoes blocking. If the point is higher than 150° C., the kneading performance of the composition lowers. Examples of this condensation copolymer made from the phenolic-hydroxyl-group-having compound, the triazine derivative, and the aldehyde-group-having compound include copolymers of the following structural formulae (XXXXXIV) to (XXXXXIX):

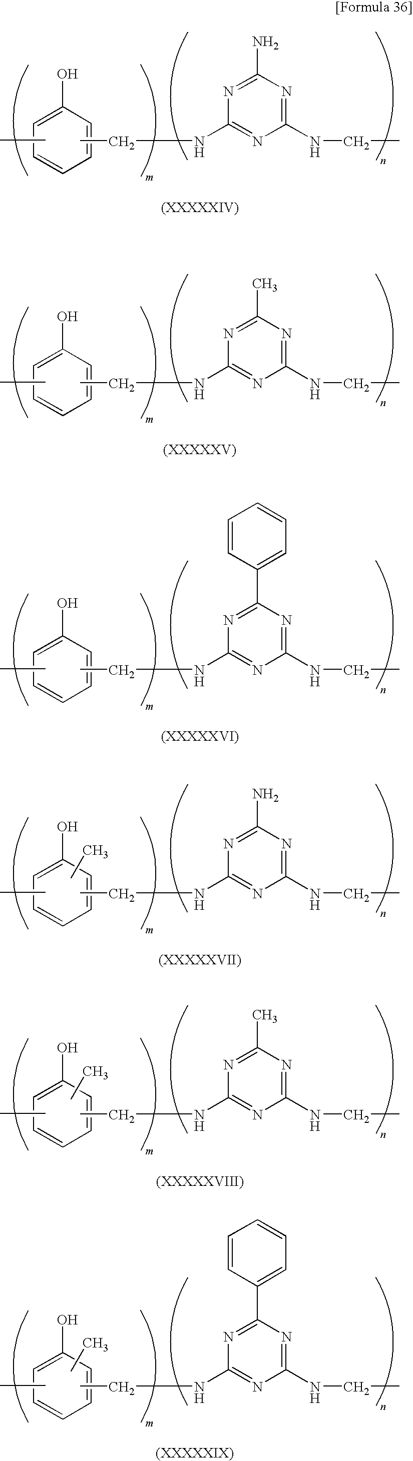

wherein m and n are each a positive number.

The number-average molecular weight of the condensation copolymer made from the phenolic-hydroxyl-group-having compound, the triazine derivative, and the aldehyde-group-having compound is preferably from 500 to 1000, more preferably from 550 to 800. If the molecular weight is less than 500, the moldability and the reflow cracking resistance lower. If the molecular weight is more than 1000, the fluidity is liable to lower. The weight-average molecular weight is preferably from 1500 to 10000, more preferably from 1700 to 7000. If the molecular weight is less than 1500, the reflow cracking resistance is liable to lower. If the molecular weight is more than 10000, the fluidity is liable to lower.

Furthermore, the molecular weight distribution Mw/Mw of the condensation copolymer of the phenolic-hydroxyl-group-having compound, the triazine derivative, and the aldehyde-group-having compound is preferably from 2.0 to 10.0, more preferably from 3.0 to 6.0. If the molecule distribution is less than 2.0, the reflow resistance is liable to lower. If the molecule distribution is more than 10.0, the fluidity is liable to lower.

Of the above-mentioned condensation copolymers, preferred is a condensation copolymer made from a phenol resin, a triazine derivative, and an aldehyde-group-having compound from the viewpoint of reflow resistance. The phenol resin used herein is not particularly limited as long as the resin is ordinarily used in compositions. An example thereof is a resin obtained by condensing or cocondensing an aldehyde-group-having compound with phenol, an alkylphenol such as cresol, xylenol, ethylphenol, butylphenol, nonylphenyl or octylphenol, a polyhydric phenol such as resorcin, catechol, bisphenol A, bisphenol F or bisphenol S, a naphthol such as α-naphthol, β-naphthol or dihydroxynaphthalene, phenylphenol, aminophenol, or some other phenol derivative in the presence of an acidic catalyst. Of species of the resin, phenol/Novolak resin, which is a condensation polymer made from phenol and formaldehyde, is preferred from the viewpoint of moldability.

As long as the phenol resin is a resin as listed up above, the synthesizing process thereof is not particularly limited. It is preferred to use a resin synthesized by the following process since the resin can be synthesized as a resin having a molecular weight and a molecular weight distribution in preferred ranges described in the invention: When the phenol resin is synthesized, about the use ratio between the phenol derivative and the aldehyde-group-having compound the amount of the aldehyde-group-having compound is set preferably into the range of 0.01 to 2.0 moles, preferably into that of 0.05 to 1.0 mole per mole of the phenol derivative. If the amount is less than 0.01 mole, the reaction becomes insufficient so that the molecular weight does not increase. As a result, the moldability, the heat resistance, the water resistance, the flame retardancy, the strength and others tend to lower. If the amount is more than 2.0 moles, the molecular weight becomes too large so that the kneading performance tends to lower.

The temperature of this reaction is preferably from 80 to 220° C., more preferably from 100 to 180° C. If the temperature is lower than 80° C., the reactivity becomes insufficient so that the molecular weight tends to become small and the moldability tends to lower. If the temperature is higher than 250° C., disadvantages are generated from the viewpoint of producing-facilities when the phenol resin is synthesized. The reaction time is preferably from about 1 to 30 hours.

If necessary, an amine catalyst such as trimethylamine or triethylamine, an acid catalyst such as p-toluenesulfonic acid or oxalic acid, an alkaline catalyst such as sodium hydroxide or ammonia, or the like may be used in an amount of about 0.00001 to 0.01 mole per mole of the phenol derivative. The pH of the reaction system is preferably set into the range of about 1 to 10.

After the phenol derivative is caused to react with the aldehyde-group-having compound in this way, unreacted fractions of the phenol derivative and the aldehyde-group-having compound, water and others can be removed by heating under a reduced pressure if necessary. Conditions therefor are preferably as follows: the temperature is from 80 to 220° C., desirably from 100 to 180° C., the pressure is 100 mmHg or less, desirably 60 mmHg or less, and the time is from 0.5 to 10 hours.

When the triazine derivative and the aldehyde-group-having compound are added to the phenol resin so as to cause reaction, about the use ratio between the triazine derivative and the aldehyde-group-having compound the amount of the triazine derivative is set preferably into the range of 3 to 50 g, preferably into that of 4 to 30 g for 100 g of the condensation polymer made from the phenol derivative and the aldehyde-group-having compound, that is, the phenol resin (the condensation polymer is a product which has undergone or has not undergone the removal of the unreacted fractions of the phenol derivative and the aldehyde-group-having compound, water, and others by the heating under the reduced pressure; however, in this case, the weight of the unreacted fraction of the phenol is also included in the weight of the condensation polymer). The amount of the aldehyde-group-having compound is set preferably into the range of 5 to 100 g, more preferably into that of 6 to 50 g for 100 g of the condensation polymer (phenol resin). When the amounts of the triazine derivative (b) and the aldehyde-group-having compound (c) are set into the above-mentioned ranges, the molecular weight distribution of the finally obtained condensation polymer and the nitrogen content by percentage therein can easily be adjusted into desired ranges.

The reaction temperature is set preferably into the range of 50 to 250° C., more preferably into that of 80 to 170° C. If the temperature is lower than 50° C., the reaction becomes insufficient so that the molecular weight tends not to increase and the moldability, the heat resistance, the water resistance, the flame retardancy, the strength and others tend to lower. If the temperature is higher than 250° C., disadvantages tend to be generated from the viewpoint of producing facilities when the target compound is synthesized. The reaction time is preferably set into the range of about 1 to 30 hours.

If necessary, it is allowable to use an amine catalyst such as trimethylamine or triethylamine or an acid catalyst such as oxalic acid in an amount of about 0.00001 to 0.01 mole per mole of the phenol derivative.

The pH of the reaction system is preferably set into the range of about 1 to 10. After the condensation product (phenol resin) made from the phenol derivative and the aldehyde-group-having compound is caused to react with the triazine derivative and the aldehyde-group-having compound, unreacted fractions of the phenol derivative and the aldehyde-group-having compound, water, and others can be removed by heating under a reduced pressure. Conditions therefor are preferably as follows: the temperature is from 80 to 180° C., the pressure is 100 mmHg or less, desirably 60 mmHg or less, and the time is from 0.5 to 10 hours. The triazine derivative (b) used in the synthesis is not particularly limited as long as the derivative is a compound having, in the molecule thereof, a triazine nucleus. Examples thereof include melamine, guanamine derivatives such as benzoguanamine and acetoguanamine, cyanuric acid, and cyanuric acid derivatives such as methyl cyanurate. These may be used alone or in combination of two or more thereof. Of the examples, preferred are melamine, and guanamine derivatives such as benzoguanamine from the viewpoint of moldability and reliability. Examples of the aldehyde-group-having compound (c) include formaldehyde, formalin, and paraformaldehyde.

In the invention, the composition may contain a silicon-containing polymer. The silicon-containing polymer is not particularly limited as long as the polymer is a polymer which has bonds (c) and (d) illustrated below, has as each of its terminals a functional group selected from R¹, a hydroxyl group and an alkoxy group, and has an epoxy equivalent of 500 to 4000. Such a polymer is, for example, branched polysiloxane.

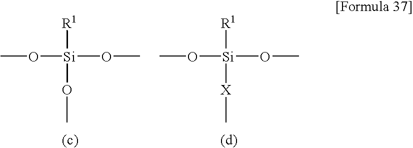

wherein R¹ is selected from substituted or unsubstituted monovalent hydrocarbon groups having 1 to 12, all R¹s in the silicon-containing polymer may wholly be the same or different, and X represents a bivalent organic group having an epoxy group.

Examples of R¹ in the general formulae (c) and (d) include alkyl groups such as methyl, ethyl, propyl, butyl, isopropyl, isobutyl, t-butyl, pentyl, hexyl, heptyl, octyl and 2-ethylhexyl groups; alkenyl groups such as vinyl, ally, butenyl, pentenyl and hexenyl groups; aryl groups such as phenyl, tolyl, xylyl, naphthyl and biphenyl groups; and aralkyl groups such as benzyl and phenethyl groups. Of the groups, preferred is a methyl or phenyl group.

Examples of X in the general formula (d) include 2,3-epoxypropylene, 3,4-epoxybuytlene, 4,5-epoxypentylene, 2-glycidoxyethylene, 3-glycidoxypropylene, 4-glycidoxybutylene, 2-(3,4-epoxycyclohexyl)ethylene, 3-(3,4-epoxycyclohexyl)propylene, 2,3-epoxypropylidene, 3-glycidoxypropylidene, and 3-(3,4-epoxycyclohexyl)propylidene groups. Of the groups, 3-glycidoxypropylene and 3-glycidoxypropylidene groups are preferred.

It is also preferred that the terminals of the silicon-containing polymer are each any one of the groups as described above, a hydroxyl group, and an alkoxy group. Examples of the alkoxy group in this case include methoxy, ethoxy, propoxy, and butoxy groups. The epoxy equivalent of the silicon-containing polymer preferably ranges from 500 to 4000, more preferably from 1000 to 2500. If the epoxy equivalent is less than 500, the fluidity of the epoxy resin composition for sealing tends to lower. If it is more than 4000, the polymer oozes easily onto the surface of the cured product and the composition tends to be unsatisfactorily molded.

The silicon-containing polymer preferably has a bond (e) illustrated below from the viewpoint of compatibility between the fluidity of the resultant epoxy resin composition for sealing and a low warpage thereof.

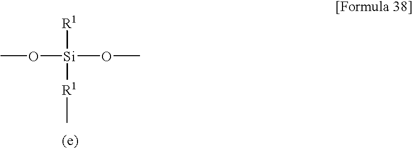

wherein R's are selected from substituted or unsubstituted monovalent hydrocarbon groups which each have 1 to 12 carbon atoms and may each turn into a bivalent, and all R¹s in the silicon-containing polymer may wholly be the same or different.

Examples of R in the general formula (e) include alkyl groups such as methyl, ethyl, propyl, butyl, isopropyl, isobutyl, t-butyl, pentyl, hexyl, heptyl, octyl and 2-ethylhexyl groups; alkenyl groups such as vinyl, ally, butenyl, pentenyl and hexenyl groups; aryl groups such as phenyl, tolyl, xylyl, naphthyl and biphenyl groups; and aralkyl groups such as benzyl and phenethyl groups. Of the groups, preferred is a methyl or phenyl group.

The softening point of such a silicon-containing polymer is set preferably into the range of 40 to 120° C., more preferably into that of 50 to 100° C. If the point is lower than 40° C., the mechanical strength of the cured product of the resultant epoxy resin composition for sealing tends to lower. If the point is higher than 120° C., the dispersibility of the silicon-containing polymer in the epoxy resin composition for sealing tends to lower. The softening point of the silicon-containing polymer can be adjusted by the molecular weight of the silicon-containing polymer, constituting bond units (for example, the ratio between the contained units (c) to (e)) therein, the kind of organic groups bonded to the silicon atoms, and others. It is preferred to set the content by percentage of the aryl group(s) in the silicon-containing polymer, thereby adjusting the softening point, in particular, from the viewpoint of the dispersibility of the silicon-containing polymer in the epoxy resin composition for sealing and the fluidity of the resultant epoxy resin composition for sealing. Examples of the aryl group(s) in this case include phenyl, tolyl, xylyl, naphthyl, and biphenyl groups. A phenyl group is more preferred. The silicon-containing polymer having a desired softening point can be obtained by setting the phenyl-group content by percentage in the monovalent organic groups bonded to the silicon atoms in the silicon-containing polymer into the range of 60 to 99% by mole, preferably 70 to 85% by mole.

The weight-average molecular weight (Mw) of the silicon-containing polymer is preferably from 1000 to 30000, more preferably from 2000 to 20000, even more preferably from 3000 to 10000 as a value obtained by measuring the polymer by gel permeation chromatography (GPC) and using a calibration curve of standard polystyrene to convert the measured value. The silicon-containing polymer is preferably a random copolymer.

Such a silicon-containing polymer can be obtained by a production process described below. As a commercially available thereof, AY42-119 (trade name) manufactured by Dow Corning Toray Silicone Co., Ltd. can be gained.

The production process of the silicon-containing polymer is not particularly limited, and may be produced by a known process. Prepared is, for example, organosilane, organoalkoxysilane or siloxane which can form the above-mentioned units (c) to (e) by hydrolytic condensation reaction, or a partially hydrolyzed condensate thereof. This is mixed with a mixed solution of an organic solvent in which the raw material and a reaction product can be dissolved, and water the amount of which is an amount which permits all hydrolyzable groups of the raw material to be hydrolyzed. The resultant is caused to undergo hydrolytic condensation reaction, whereby the silicon-containing polymer can be yielded. At this time, in order to decrease the amount of chlorine contained as an impurity in the epoxy resin composition for sealing, it is preferred to use organoalkoxysilane and/or siloxane as the raw material. In this case, it is preferred to add an acid, base or organometallic compound as a catalyst for promoting the reaction.

Examples of the organoalkoxysilane and/or siloxane, as the raw material of the silicon-containing polymer, include methyltrimethoxysilane, methyltriethoxysilane, ethyltrimethoxysilane, ethyltriethoxysilane, vinyltrimethoxysilane, vinyltriethoxysilane, phenyltrimethoxysilane, phenyltriethoxysilane, dimethyldimethoxysilane, methylphenyldimethoxysilane, methylvinyldimethoxysilane, phenylvinyldimethoxysilane, diphenyldimethoxysilane, methylphenyldiethoxysilane, methylvinyldiethoxysilane, phenylvinyldiethoxysilane, diphenyldiethoxysilane, dimethyldiethoxysilane, tetramethoxysilane, tetraethoxysilane, dimethoxydiethoxysilane, 3-glycidoxypropyltrimethoxysilane, 3-glycidoxypropyltriethoxysilane, 3-glycidoxypropyl(methyl)dimethoxysilane, 3-glycidoxypropyl(methyl)diethoxysilane, 3-glycidoxypropyl(phenyl)dimethoxysilane, 3-glycidoxypropyl(phenyl)diethoxysilane, 2-(3,4-epoxycyclohexyl)ethyl(methyl)dimethoxysilane, 2-(3,4-epoxycyclohexyl)ethyl(methyl)diethoxysilane, 2-(3,4-epoxycyclohexyl)ethyl(phenyl)dimethoxysilane and 2-(3,4-epoxycyclohexyl)ethyl(phenyl)diethoxysilane; and hydrolytic condensates thereof.

The content by percentage of the silicon-containing polymer is not particularly limited, and is preferably from 0.2 to 1.5% by mass of the total of the epoxy resin composition for sealing, more preferably from 0.3 to 1.3% by mass thereof. If the content is less than 0.2% by mass, the addition effect of the silicon-containing polymer tends to decline. If the content is more than 1.5% by mass, the thermal time hardness of the resultant epoxy resin composition for sealing tends to decline.

In order to improve the humidity resistance and the high-temperature-standing property of a semiconductor element such as an IC, the composition may optionally contain a compound represented by the following composition formula (XXXXXX) and/or a compound represented by the following composition formula (XXXXXXI):

Mg_{1-X}Al_{X}(OH)₂(CO₃)_{X/2}.mH₂O [Formula 39]

(XXXXXX)

wherein 0<X≦0.5, and m is a positive number; and

BiOₓA(OH)_{y}(NO₃)_{z} [Formula 40]

(XXXXXXI)

wherein 0.9≦x≦1.1, and 0.6≦y≦0.8, and 0.2≦z≦0.4.

The compound of the formula (XXXXXX) can be gained as DHT-4A (trade name) manufactured by Kyowa Chemical Industry Co., Ltd. as a commercially available. The compound of the formula (XXXXXXI) can be gained as IXE500 (trade name) manufactured by Toagosei Co., Ltd. as a commercially available. A different anion exchanger may be optionally added thereto. The anion exchanger is not particularly limited, and may be an anionic exchanger known in the prior art. Examples thereof include hydrated hydroxides of an element selected from magnesium, aluminum, titanium, zirconium, antimony and others. These may be used alone or in combination of two or more thereof.

Furthermore, other additives may be incorporated into the epoxy resin composition of the invention for sealing, examples of additives including releasing agents such as higher fatty acids, higher fatty acid metal salts, ester waxes, polyolefin waxes, polyethylene and oxidized polyethylene; colorants such as carbon black; and stress relaxing agents such as silicone oil and silicone rubber powder.

About the epoxy resin composition of the invention for sealing, it is preferred from the viewpoint of flame retardancy that the epoxy resin (A) and the curing agent (B) are beforehand melted and mixed with each other and the mixture is used. The method for the melting and mixing is not particularly limited. The two are heated at a temperature not lower than the temperature at which the two or one of the two is melted, and the two are stirred and mixed with each other until the mixture becomes homogeneous. In order not to cause gelation at this time, it is preferred to check the reactivity by GPC (gel permeation chromatography), FT-IR or the like, and set optimal conditions. When the compound of the general formula (I) is used as the curing agent (B), it is preferred to perform the stirring, melting and mixing at 80 to 120° C., preferably 90 to 120° C. for 10 to 60 minutes, preferably 20 to 40 minutes.

The epoxy resin composition of the invention for sealing can be prepared by any method as long as the method is a method making it possible to disperse and mix the individual raw materials homogeneously. An ordinary example of the method is a method of mixing the raw materials having predetermined amounts sufficiently with each other by means of a mixer or the like, mixing or melting/kneading the materials by means of a mixing roll, an extruder, a mortar and pestle machine, a planetary mixer or the like, cooling the mixture, and optionally defoaming or pulverizing the resultant. The resultant may optionally be made into the form of tablets having a size and a weight corresponding to molding conditions.

The method for sealing an electron component device such as a semiconductor device by use of the epoxy resin composition of the invention for sealing is most popularly low-pressure transfer molding. The method may be injection molding, compression molding or the like. A discharging manner, a casting manner, a printing manner or the like may be used.

An example of an electronic component device equipped with an element sealed with the epoxy resin molding material, for sealing, obtained according to the invention is an electronic component device wherein: active elements, such as a semiconductor chip, a transistor, a diode and a thyristor, passive elements such as a condenser, a resistor and a coil, and other elements are mounted on a supporting member or a mounting substrate such as a lead frame, a wired tape carrier, a wired board, a glass piece or a silicon wafer; and required portions are sealed with the epoxy resin molding material of the invention for sealing.

The mounting substrate is not particularly limited, and examples thereof include interposer substrates such as an organic substrate, an organic film, a ceramic substrate and a glass substrate, a glass substrate for liquid crystal, a substrate for an MCM (multi chip module), and a substrate for a hybrid IC.

An electron component device equipped with such an element is, for example, a semiconductor device. Specific examples thereof include a DIP (dual inline package), a PLCC (plastic leaded chip carrier), a QFP (quad flat package), an SOP (small outline package), an SOJ (small outline J-lead package), a TSOP (thin small outline package), a TQFP (thin quad flat package), and other resin-sealed ICs, wherein semiconductor elements such as semiconductor chips are fixed on a lead frame (islands and tabs), terminal regions of the elements, such as bonding pads thereof, are connected to lead regions through wire bonding or bumps, and then the resultant is sealed by transfer molding or the like, using the epoxy resin composition of the invention for sealing; a TCP (tape carrier package), wherein semiconductor chips lead-bonded to a tape carrier are sealed with the epoxy resin composition of the invention for sealing; a COB (chip on board), a COG (chip on glass), and some other bare-chip-mounted semiconductor device, wherein semiconductor chips connected to wiring formed on a wiring board or a glass piece by wire bonding, flip chip bonding, solder or the like are sealed with the epoxy resin composition of the invention for sealing; a hybrid IC, wherein active elements, such as a semiconductor chip, a transistor, a diode and a thyristor, and/or passive elements, such as a condenser, a resistor and a coil, connected to wiring formed on a wiring board or a glass piece by wire bonding, flip chip bonding, solder or the like are sealed with the epoxy resin composition of the invention for sealing; an MCM (multi chip module); and a BGA (ball grid array), a CSP (chip size package) and an MCP (multi chip package), wherein semiconductor chips are mounted on an interposer substrate on which terminals for connection to a mother board are formed, the semiconductor chips are connected to wiring formed on the interposer substrate through bumps or wire bonding, and then the resultant is sealed, on a side thereof on which the semiconductor chips are mounted, with the epoxy resin composition of the invention for sealing. These semiconductor devices may be stacked type packages, wherein two or more elements are mounted, on a mounting substrate, into the form that they are stacked on each other, or collectively-molded packages, wherein two or more elements are sealed at a time with the epoxy resin composition for sealing.

### EXAMPLES

The invention will be described by way of the following examples; however, the scope of the invention is not limited to these examples.

### Examples 1 to 27, and Comparative Examples 1 to 14

The following were prepared as epoxy resins (A): an o-cresol Novolak type epoxy resin having an epoxy equivalent of 190 and a softening point of 65° C. (trade name: YDCN-500, manufactured by Tohto Kasei Co., Ltd.) (epoxy resin 1); a biphenyl type epoxy resin having an epoxy equivalent of 196 and a melting point of 106° C. (EPIKOTE [YX-4000H, manufactured by Japan Epoxy Resins Co., Ltd.) (epoxy resin 2); a sulfur-atom-containing epoxy resin having an epoxy equivalent of 245 and a melting point of 110° C. (tradename: YSLV-120TE, manufactured by Tohto Kasei Co., Ltd.) (epoxy resin 3); a biphenylene type epoxy resin having an epoxy equivalent of 273 and a softening point of 58° C. (trade name: NC-3000, manufactured by Nippon Kayaku Co., Ltd.) (epoxy resin 4); and a compound represented by the general formula (XXXIII) wherein m is 2, and having an epoxy equivalent of 316 and a softening point of 72° C. (trade name: ENP-80, manufactured by Tohto Kasei Co., Ltd.) (epoxy resin 5).

The following were prepared as curing agents (B): a compound (C) represented by the general formula (I) wherein R¹ and R² are each a hydrogen atom and M/(N+M) is 0.1, and having a hydroxyl equivalent of 186 and a softening point of 72° C. (trade name: HE-610C, manufactured by Air water Inc.) (curing agent 1);

a compound (C) represented by the general formula (I) wherein R¹ and R² are each a hydrogen atom and M/(N+M) is 0.2, and having a hydroxyl equivalent of 175 and a softening point of 76° C. (trade name: HE-620C, manufactured by Air Water Inc.) (curing agent 5); a compound (C) represented by the general formula (I) wherein R¹ and R² were each a hydrogen atom and M/(N+M) was 0.03, and having a hydroxyl equivalent of 194 and a softening point of 69° C. (curing agent 6);

a compound (C) represented by the general formula (I) wherein R¹ and R² were each a hydrogen atom and M/(N+M) was 0.6, and having a hydroxyl equivalent of 131 and a softening point of 76° C. (curing agent 7);

a phenol Novolak resin having a softening point of 80° C. and a hydroxyl equivalent of 106 (trade name: H-1, manufactured by Meiwa Chemical Industry Co., Ltd.) (curing agent 2);

a phenol/aralkyl resin having a softening point of 70° C. and a hydroxyl equivalent of 175 (tradename: MIREX XLC-3L, manufactured by Mitsui Chemicals, Inc.) (curing agent 3); and

a biphenylene type phenol resin having a softening point of 80° C. and a hydroxyl equivalent of 199 (trade name: MEH-7851, manufactured by Meiwa Chemical Industry Co., Ltd.) (curing agent 4).

Prepared were triphenylphosphine (curing promoter 1) and an adduct of triphenylphosphine and 1,4-benzoquinone (curing promoter 2) as curing promoters (D); and γ-glycidoxypropyltrimethoxysilane (epoxysilane) and a silane coupling agent having a secondary amino group (γ-anilinopropyltrimethoxysilane) (anilinosilane) as coupling agents (F).

As flame retardants, prepared were an aromatic condensed phosphate (trade name: PX-200, manufactured by Daihachi Chemical Industry Co., Ltd.); triphenylphosphine oxide; cyclophospahzene (trade name: SPE-100, manufactured by Ohtsuka Chemical industrial Co., Ltd.); a magnesium hydroxide/zinc hydroxide solid solution composite metal hydroxide (trade name: ECHO MAG Z-10, manufactured by Tateho Chemical Industries Co., Ltd.); antimony trioxide; and a bisphenol A type brominated epoxy resin having an epoxy equivalent of 397, a softening point of 69° C. and a bromine content of 49% by mass (YDB-400, manufactured by Tohto Kasei Co., Ltd.).

Prepared were a spherical silica having an average particle diameter of 14.5 μm and a specific surface area of 2.8 m²/g as an inorganic filler (E); and carnauba wax (manufactured by Clariant Co.) and a carbon black (trade name: MA-100, manufactured by Mitsubishi Chemical Corp.) as other additives.

These were blended to account for individual parts by mass shown in Tables 1 to 5, and the resultant blends were each kneaded with rolls at a kneading temperature of 80° C. for a kneading time of 10 minutes to produce epoxy resin compositions of Examples 1 to 24 and Comparative Examples 1 to 14. In the tables, blanks each mean that the corresponding component was not blended.

TABLE 1
Blend composition 1

| Blend | Example | | | | | | | | |
|---|---|---|---|---|---|---|---|---|---|
| composition | 1 | 2 | 3 | 4 | 5 | 6 | 7 | 8 | 9 |
| epoxy resin 1 | 100 | | | | | | | | |
| epoxy resin 2 | | 100 | | | | 20 | 40 | 50 | 60 |
| epoxy resin 3 | | | 100 | | | | | | |
| epoxy resin 4 | | | | 100 | | 80 | 60 | 50 | 40 |
| epoxy resin 5 | | | | | 100 | | | | |
| brominated | | | | | | | | | |
| epoxy resin | | | | | | | | | |
| curing agent 1 | 98 | 95 | 76 | 68 | 59 | 73 | 79 | 82 | 84 |
| curing agent 2 | | | | | | | | | |
| curing agent 3 | | | | | | | | | |
| curing agent 4 | | | | | | | | | |
| curing agent 5 | | | | | | | | | |
| curing agent 6 | | | | | | | | | |
| curing agent 7 | | | | | | | | | |
| curing | | | | | | | | | |
| promoter 1 | | | | | | | | | |
| curing | 3.0 | 3.0 | 3.0 | 3.0 | 3.0 | 3.0 | 3.0 | 3.0 | 3.0 |
| promoter 2 | | | | | | | | | |
| phosphate | | | | | | | | | |
| triphenyl | | | | | | | | | |
| phosphine oxide | | | | | | | | | |
| Cyclo | | | | | | | | | |
| phospahzene | | | | | | | | | |
| composite metal | | | | | | | | | |
| hydroxide | | | | | | | | | |
| antimony | | | | | | | | | |
| trioxide | | | | | | | | | |
| epoxysilane | 1.0 | 1.0 | 1.0 | 1.0 | 1.0 | 1.0 | 1.0 | 1.0 | 1.0 |
| anilinosilane | | | | | | | | | |
| carnauba wax | 2.0 | 2.0 | 2.0 | 2.0 | 2.0 | 2.0 | 2.0 | 2.0 | 2.0 |
| carbon black | 2.5 | 2.5 | 2.5 | 2.5 | 2.5 | 2.5 | 2.5 | 2.5 | 2.5 |
| fused silica | 1105 | 1089 | 987 | 945 | 896 | 974 | 1003 | 1017 | 1031 |
| filler content | 84 | 84 | 84 | 84 | 84 | 84 | 84 | 84 | 84 |
| (mass %) | | | | | | | | | |

TABLE 2
Blend composition 2

| Blend | Example | | | | | | | | |
|---|---|---|---|---|---|---|---|---|---|
| composition | 10 | 11 | 12 | 13 | 14 | 15 | 16 | 17 | 18 |
| epoxy resin 1 | | 80 | 60 | 50 | 40 | 20 | | | |
| epoxy resin 2 | 80 | | | | | | | | |
| epoxy resin 3 | | | | | | | | | |
| epoxy resin 4 | 20 | | | | | | 100 | 100 | 100 |
| epoxy resin 5 | | 20 | 40 | 50 | 60 | 80 | | | |
| brominated | | | | | | | | | |
| epoxy resin | | | | | | | | | |
| curing agent 1 | 90 | 90 | 82 | 78 | 74 | 67 | 68 | 68 | 34 |
| curing agent 2 | | | | | | | | | 19 |
| curing agent 3 | | | | | | | | | |
| curing agent 4 | | | | | | | | | |
| curing agent 5 | | | | | | | | | |
| curing agent 6 | | | | | | | | | |
| curing agent 7 | | | | | | | | | |
| curing | | | | | | | 3.0 | | |
| promoter 1 | | | | | | | | | |
| curing | 3.0 | 3.0 | 3.0 | 3.0 | 3.0 | 3.0 | | 3.0 | 3.0 |
| promoter 2 | | | | | | | | | |
| phosphate | | | | | | | | | |
| triphenyl | | | | | | | | | |
| phosphine oxide | | | | | | | | | |
| Cyclo | | | | | | | | | |
| phospahzene | | | | | | | | | |
| composite metal | | | | | | | | | |
| hydroxide | | | | | | | | | |
| antimony | | | | | | | | | |
| trioxide | | | | | | | | | |
| epoxysilane | 1.0 | 1.0 | 1.0 | 1.0 | 1.0 | 1.0 | 1.0 | | 1.0 |
| anilinosilane | | | | | | | | 1.0 | |
| carnauba wax | 2.0 | 2.0 | 2.0 | 2.0 | 2.0 | 2.0 | 2.0 | 2.0 | 2.0 |
| carbon black | 2.5 | 2.5 | 2.5 | 2.5 | 2.5 | 2.5 | 2.5 | 2.5 | 2.5 |
| fused silica | 1060 | 1063 | 1021 | 1000 | 979 | 937 | 945 | 945 | 867 |
| filler content | 84 | 84 | 84 | 84 | 84 | 84 | 84 | 84 | 84 |
| (mass %) | | | | | | | | | |

TABLE 3
Blend composition 3

| Blend | Example | | | | | | | | |
|---|---|---|---|---|---|---|---|---|---|
| composition | 19 | 20 | 21 | 22 | 23 | 24 | 25 | 26 | 27 |
| epoxy resin 1 | | | 100 | 100 | 100 | 100 | | | |
| epoxy resin 2 | | | | | | | 100 | 100 | 100 |
| epoxy resin 3 | | | | | | | | | |
| epoxy resin 4 | 100 | 100 | | | | | | | |
| epoxy resin 5 | | | | | | | | | |
| brominated | | | | | | | | | |
| epoxy resin | | | | | | | | | |
| curing agent 1 | 34 | 34 | 98 | 98 | 98 | 98 | | | |
| curing agent 2 | | | | | | | | | |
| curing agent 3 | 32 | | | | | | | | |
| curing agent 4 | | 36 | | | | | | | |
| curing agent 5 | | | | | | | 89 | | |
| curing agent 6 | | | | | | | | 99 | |
| curing agent 7 | | | | | | | | | 67 |
| curing | | | | | | | | | |
| promoter 1 | | | | | | | | | |
| curing | 3.0 | 3.0 | 3.0 | 3.0 | 3.0 | 3.0 | 3.0 | 3.0 | 3.0 |
| promoter 2 | | | | | | | | | |
| phosphate | | | 10.0 | | | | | | |
| triphenyl | | | | 10.0 | | | | | |
| phosphine oxide | | | | | | | | | |
| Cyclo | | | | | 10.0 | | | | |
| phospahzene | | | | | | | | | |
| composite metal | | | | | | 50.0 | | | |
| hydroxide | | | | | | | | | |
| antimony | | | | | | | | | |
| trioxide | | | | | | | | | |
| epoxysilane | 1.0 | 1.0 | 1.0 | 1.0 | 1.0 | 1.0 | 1.0 | 1.0 | 1.0 |
| anilinosilane | | | | | | | | | |
| carnauba wax | 2.0 | 2.0 | 2.0 | 2.0 | 2.0 | 2.0 | 2.0 | 2.0 | 2.0 |
| carbon black | 2.5 | 2.5 | 2.5 | 2.5 | 2.5 | 2.5 | 2.5 | 2.5 | 2.5 |
| fused silica | 935 | 958 | 1158 | 1158 | 1158 | 1055 | 1058 | 1110 | 938 |
| filler content | 84 | 84 | 84 | 84 | 84 | 84 | 84 | 84 | 84 |
| (mass %) | | | | | | | | | |

TABLE 4
Blend composition 4

| Blend | Comparative Example | | | | | | | | |
|---|---|---|---|---|---|---|---|---|---|
| composition | 1 | 2 | 3 | 4 | 5 | 6 | 7 | 8 | 9 |
| epoxy resin 1 | | | | | | | 100 | 100 | 100 |
| epoxy resin 2 | | | | 100 | 100 | 100 | | | |
| epoxy resin 3 | | | | | | | | | |
| epoxy resin 4 | 100 | 100 | 100 | | | | | | |
| epoxy resin 5 | | | | | | | | | |
| brominated | | | | | | | | | |
| epoxy resin | | | | | | | | | |
| curing agent 1 | | | | | | | | | |
| curing agent 2 | 39 | | | 54 | | | 56 | | |
| curing agent 3 | | 64 | | | 89 | | | 92 | |
| curing agent 4 | | | 73 | | | 102 | | | 105 |
| curing agent 5 | | | | | | | | | |
| curing agent 6 | | | | | | | | | |
| curing agent 7 | | | | | | | | | |
| curing | | | | | | | | | |
| promoter 1 | | | | | | | | | |
| curing | 3.0 | 3.0 | 3.0 | 3.0 | 3.0 | 3.0 | 3.0 | 3.0 | 3.0 |
| promoter 2 | | | | | | | | | |
| phosphate | | | | | | | | | |
| triphenyl | | | | | | | | | |
| phosphine oxide | | | | | | | | | |
| Cyclo | | | | | | | | | |
| phospahzene | | | | | | | | | |
| composite metal | | | | | | | | | |
| hydroxide | | | | | | | | | |
| antimony | | | | | | | | | |
| trioxide | | | | | | | | | |
| epoxysilane | 1.0 | 1.0 | 1.0 | 1.0 | 1.0 | 1.0 | 1.0 | 1.0 | 1.0 |
| anilinosilane | | | | | | | | | |
| carnauba wax | 2.0 | 2.0 | 2.0 | 2.0 | 2.0 | 2.0 | 2.0 | 2.0 | 2.0 |
| carbon black | 2.5 | 2.5 | 2.5 | 2.5 | 2.5 | 2.5 | 2.5 | 2.5 | 2.5 |
| fused silica | 788 | 924 | 971 | 870 | 1058 | 1092 | 879 | 1074 | 1141 |
| filler content | 84 | 84 | 84 | 84 | 84 | 84 | 84 | 84 | 84 |
| (mass %) | | | | | | | | | |

TABLE 5
Blend composition 5

| Blend | Comparative Example | | | | |
|---|---|---|---|---|---|
| composition | 10 | 11 | 12 | 13 | 14 |
| epoxy resin 1 | 85 | 100 | 100 | 100 | 100 |
| epoxy resin 2 | | | | | |
| epoxy resin 3 | | | | | |
| epoxy resin 4 | | | | | |
| epoxy resin 5 | | | | | |
| brominated | 15 | | | | |
| epoxy resin | | | | | |
| curing agent 1 | | | | | |
| curing agent 2 | 51 | | | | |
| curing agent 3 | | 92 | 92 | 92 | 92 |
| curing agent 4 | | | | | |
| curing agent 5 | | | | | |
| curing agent 6 | | | | | |
| curing agent 7 | | | | | |
| curing | | | | | |
| promoter 1 | | | | | |
| curing | 3.0 | 3.0 | 3.0 | 3.0 | 3.0 |
| promoter 2 | | | | | |
| phosphate | | 30.0 | | | |
| triphenyl | | | 30.0 | | |
| phosphine oxide | | | | | |
| Cyclo | | | | 30.0 | |
| phospahzene | | | | | |
| composite metal | | | | | 100.0 |
| hydroxide | | | | | |
| antimony | 6.0 | | | | |
| trioxide | | | | | |
| epoxysilane | 1.0 | 1.0 | 1.0 | 1.0 | 1.0 |
| anilinosilane | | | | | |
| carnauba wax | 2.0 | 2.0 | 2.0 | 2.0 | 2.0 |
| carbon black | 2.5 | 2.5 | 2.5 | 2.5 | 2.5 |
| fused silica | 856 | 1234 | 1234 | 1234 | 974 |
| filler content | 84 | 84 | 84 | 84 | 84 |
| (mass %) | | | | | |

Properties of the produced epoxy resin compositions of Examples 1 to 27 and Comparative Examples 1 to 14 for sealing were obtained by individual tests described below. The results are shown in Tables 6 to 10.

### (1) Spiral Flow

A spiral-flow-measuring mold according to the standard of EMMI-1-66 was used to mold each of the epoxy resin compositions for sealing by means of a transfer molding machine under conditions that the mold temperature was 180° C., the molding pressure was 6.9 MPa and the curing time was 90 seconds. The flow distance (cm) thereof was obtained.

(2) Hardness when Heated

Each of the epoxy resin compositions for sealing was molded into a disc having a diameter of 50 mm and a thickness of 3 mm under the conditions in the item (1). Immediately after the molding, a Shore D hardness meter was used to measure the hardness thereof.

### (3) Flame Retardancy

A mold for molding a test piece 1/16 inch (about 1.6 mm) in thickness was used to mold each of the epoxy resin compositions for sealing under the conditions in the item (1), and then post-cure the resultant at 180° C. for 5 hours. In accordance with the UL-94 test method, the flame retardancy was evaluated.

### (4) Reflow Resistance

Each of the epoxy resin compositions for sealing was used to form 80-pin flat packages (QFP) (products wherein lead tips were treated with silver plating, lead frame material: copper alloy) each having an outside dimension of 20 mm×14 mm×2 mm and each having a mounted silicon chip, 8 mm×10 mm×0.4 mm, by molding and post-curing under the conditions in the item (3). The packages were each humidified at 85° C. and 85% RH, and then subjected to reflow treatment at 240° C. for 10 seconds at intervals of a predetermined time. It was then observed whether the packages were cracked or not. The reflow resistance was evaluated on the basis of the number of cracked packages for the number (5) of the test packages.

### (5) Humidity Resistance

Each of the epoxy resin compositions for sealing was used to form 80-pin flat packages (QFP) each having an outside dimension of 20 mm×14 mm×2.7 mm and each having a mounted testing silicon chip, 6 mm×6 mm×0.4 mm, by molding and post-curing under the conditions in the item (3), the testing silicon chip being a chip wherein aluminum wiring having a line width of 10 μm and a thickness of 1 μm was formed on an oxide film having a thickness of 5 μm. After the resultants were pre-treated, the resultants were humidified. At intervals of a predetermined time, a wire-breaking defectiveness based on corrosion of the aluminum wiring was checked. The humidity resistance was evaluated on the basis of the number of defective packages for the number (10) of the test packages.

In the pre-treatment, the flat packages were humidified at 85° C. and 85% RH for 72 hours, and then the resultants were subjected to vapor phase reflow treatment at 215° C. for 90 seconds. The subsequent humidification was performed at 121° C. under 0.2 MPa.

### (6) High-Temperature-Standing Property

A silver paste was used to mount a testing silicon chip, 5 mm×9 mm×0.4 mm, wherein aluminum wiring having a line width of 10 μm and a thickness of 1 μm was formed on an oxide film having a thickness of 5 μm, onto a 42-alloy lead frame partially subjected to silver plating. Each of the epoxy resin compositions for sealing was used to form 16-pin type DIPs (dual inline packages), in each of which bonding pads of the chip were connected to inner leads of the chip through Au lines at 200° C. by thermo sonic type wire bonding machine, by molding and post-curing under the conditions in the item (3). The packages were stored in a high-temperature tank of 200° C. temperature. At intervals of a predetermined time, the packages were taken out, and then subjected to a continuity test. The high-temperature standing property was evaluated on the basis of the number of continuity-failure packages for the number (10) of the test packages.

TABLE 6
Property of sealant 1

| | Example | | | | | | | | |
|---|---|---|---|---|---|---|---|---|---|
| Property | 1 | 2 | 3 | 4 | 5 | 6 | 7 | 8 | 9 |
| Flame retardancy | | | | | | | | | |
| Total flaming | 45 | 33 | 40 | 21 | 12 | 22 | 25 | 26 | 30 |
| time(s) | | | | | | | | | |
| Judgment | V-0 | V-0 | V-0 | V-0 | V-0 | V-0 | V-0 | V-0 | V-0 |
| Spiral flow (cm) | 93 | 110 | 107 | 98 | 97 | 100 | 101 | 102 | 105 |
| Hardness when | 83 | 78 | 77 | 80 | 72 | 80 | 80 | 79 | 78 |
| heated (Shore D) | | | | | | | | | |
| Reflow resistance | | | | | | | | | |
| 48 h | 0/5 | 0/5 | 0/5 | 0/5 | 0/5 | 0/5 | 0/5 | 0/5 | 0/5 |
| 72 h | 0/5 | 0/5 | 0/5 | 0/5 | 0/5 | 0/5 | 0/5 | 0/5 | 0/5 |
| 96 h | 5/5 | 0/5 | 0/5 | 0/5 | 0/5 | 0/5 | 0/5 | 0/5 | 5/5 |
| 168 h | 5/5 | 5/5 | 0/5 | 1/5 | 3/5 | 2/5 | 2/5 | 3/5 | 3/5 |
| Humidity resistance | | | | | | | | | |
| 100 h | 0/10 | 0/10 | 0/10 | 0/10 | 0/10 | 0/10 | 0/10 | 0/10 | 0/10 |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 0/10 | 0/10 | 0/10 |
| 3000 h | 0/10 | 0/10 | 0/10 | 0/10 | 0/10 | 0/10 | 0/10 | 0/10 | 0/10 |
| High-temperature- | | | | | | | | | |
| standing property | | | | | | | | | |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 0/10 | 0/10 | 0/10 |

TABLE 7
Property of sealant 2

| | Example | | | | | | | | |
|---|---|---|---|---|---|---|---|---|---|
| Property | 10 | 11 | 12 | 13 | 14 | 15 | 16 | 17 | 18 |
| Flame retardancy | | | | | | | | | |
| Total flaming | 30 | 38 | 25 | 20 | 17 | 15 | 30 | 18 | 38 |
| time(s) | | | | | | | | | |
| Judgment | V-0 | V-0 | V-0 | V-0 | V-0 | V-0 | V-0 | V-0 | V-0 |
| Spiral flow (cm) | 108 | 93 | 94 | 94 | 94 | 94 | 86 | 102 | 95 |
| Hardness when | 78 | 82 | 81 | 80 | 77 | 75 | 75 | 82 | 83 |
| heated (Shore D) | | | | | | | | | |
| Reflow resistance | | | | | | | | | |
| 48 h | 0/5 | 0/5 | 0/5 | 0/5 | 0/5 | 0/5 | 0/5 | 0/5 | 0/5 |
| 72 h | 0/5 | 0/5 | 0/5 | 0/5 | 0/5 | 0/5 | 0/5 | 0/5 | 0/5 |
| 96 h | 1/5 | 4/5 | 3/5 | 1/5 | 0/5 | 0/5 | 0/5 | 0/5 | 1/5 |
| 168 h | 3/5 | 5/5 | 5/5 | 5/5 | 5/5 | 4/5 | 5/5 | 5/5 | 5/5 |
| Humidity resistance | | | | | | | | | |
| 100 h | 0/10 | 0/10 | 0/10 | 0/10 | 0/10 | 0/10 | 0/10 | 0/10 | 0/10 |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 0/10 | 0/10 | 0/10 |
| 3000 h | 0/10 | 0/10 | 0/10 | 0/10 | 0/10 | 0/10 | 3/10 | 0/10 | 0/10 |
| High-temperature- | | | | | | | | | |
| standing property | | | | | | | | | |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 2/10 | 0/10 | 0/10 |

TABLE 8
Property of sealant 3

| | Example | | | | | | | | |
|---|---|---|---|---|---|---|---|---|---|
| Property | 19 | 20 | 21 | 22 | 23 | 24 | 25 | 26 | 27 |
| Flame retardancy | | | | | | | | | |
| Total flaming | 32 | 25 | 23 | 29 | 29 | 12 | 40 | 25 | 46 |
| time(s) | | | | | | | | | |
| Judgment | V-0 | V-0 | V-0 | V-0 | V-0 | V-0 | V-0 | V-0 | V-0 |
| Spiral flow (cm) | 99 | 95 | 114 | 113 | 111 | 82 | 112 | 104 | 113 |
| Hardness when | 81 | 74 | 76 | 78 | 74 | 78 | 80 | 74 | 82 |
| heated (Shore D) | | | | | | | | | |
| Reflow resistance | | | | | | | | | |
| 48 h | 0/5 | 0/5 | 0/5 | 0/5 | 0/5 | 0/5 | 0/5 | 0/5 | 0/5 |
| 72 h | 0/5 | 0/5 | 0/5 | 0/5 | 0/5 | 0/5 | 0/5 | 0/5 | 0/5 |
| 96 h | 0/5 | 0/5 | 0/5 | 1/5 | 0/5 | 5/5 | 2/5 | 0/5 | 4/5 |
| 168 h | 3/5 | 1/5 | 5/5 | 5/5 | 5/5 | 5/5 | 5/5 | 2/5 | 5/5 |
| Humidity resistance | | | | | | | | | |
| 100 h | 0/10 | 0/10 | 0/10 | 0/10 | 0/10 | 0/10 | 0/10 | 0/10 | 0/10 |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 1/10 | 0/10 | 0/10 | 0/10 | 0/10 | 0/10 | 0/10 |
| 2000 h | 0/10 | 0/10 | 2/10 | 1/10 | 0/10 | 0/10 | 0/10 | 0/10 | 0/10 |
| 3000 h | 0/10 | 0/10 | 4/10 | 3/10 | 3/10 | 0/10 | 0/10 | 0/10 | 0/10 |
| High-temperature- | | | | | | | | | |
| standing property | | | | | | | | | |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 1/10 | 0/10 | 0/10 | 0/10 | 0/10 | 0/10 | 0/10 |

TABLE 9
Property of sealant 4

| | Comparative Example | | | | | | | | |
|---|---|---|---|---|---|---|---|---|---|
| Property | 1 | 2 | 3 | 4 | 5 | 6 | 7 | 8 | 9 |
| Flame retardancy | | | | | | | | | |
| Total flaming | 82 | 54 | 39 | 106 | 79 | 46 | burnt | 99 | 67 |
| time(s) | | | | | | | to | | |
| | | | | | | | clamp | | |
| Judgment | Off | V-1 | V-0 | Off | V-1 | V-0 | Off | Off | V-1 |
| Spiral flow (cm) | 95 | 96 | 92 | 102 | 110 | 112 | 92 | 95 | 94 |
| Hardness when | 83 | 79 | 68 | 78 | 73 | 69 | 85 | 81 | 75 |
| heated (Shore D) | | | | | | | | | |
| Reflow resistance | | | | | | | | | |
| 48 h | 0/5 | 0/5 | 0/5 | 0/5 | 0/5 | 0/5 | 2/5 | 0/5 | 0/5 |
| 72 h | 2/5 | 0/5 | 0/5 | 0/5 | 0/5 | 0/5 | 5/5 | 3/5 | 1/5 |
| 96 h | 5/5 | 0/5 | 0/5 | 3/5 | 0/5 | 0/5 | 5/5 | 5/5 | 5/5 |
| 168 h | 5/5 | 2/5 | 1/5 | 5/5 | 5/5 | 2/5 | 5/5 | 5/5 | 5/5 |
| Humidity resistance | | | | | | | | | |
| 100 h | 0/10 | 0/10 | 0/10 | 0/10 | 0/10 | 0/10 | 0/10 | 0/10 | 0/10 |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 0/10 | 0/10 | 0/10 |
| 3000 h | 0/10 | 0/10 | 0/10 | 0/10 | 0/10 | 0/10 | 0/10 | 0/10 | 0/10 |
| High-temperature- | | | | | | | | | |
| standing property | | | | | | | | | |
| 500 h | 0/10 | 0/10 | 0/10 | 0/10 | 0/10 | 0/10 | 0/10 | 0/10 | 0/10 |
| 1000 h | 0/10 | 0/10 | 0/10 | 0/10 | 0/10 | 0/10 | 0/10 | 0/10 | 0/10 |
| 1500 h | 0/10 | 0/10 | 0/10 | 0/10 | 0/10 | 0/10 | 0/10 | 0/10 | 0/10 |
| 2000 h | 0/10 | 0/10 | 0/10 | 0/10 | 0/10 | 0/10 | 0/10 | 0/10 | 0/10 |

TABLE 10
Property of sealant 5

| | Comparative Example | | | | |
|---|---|---|---|---|---|
| Property | 10 | 11 | 12 | 13 | 14 |
| Flame retardancy | | | | | |
| Total flaming | 5 | 32 | 37 | 40 | 26 |
| time(s) | | | | | |
| Judgment | V-0 | V-0 | V-0 | V-0 | V-0 |
| Spiral flow (cm) | 95 | 102 | 100 | 103 | 83 |
| Hardness when | 85 | 75 | 77 | 74 | 78 |
| heated (Shore D) | | | | | |
| Reflow resistance | | | | | |
| 48 h | 5/5 | 0/5 | 0/5 | 0/5 | 0/5 |
| 72 h | 5/5 | 0/5 | 0/5 | 0/5 | 5/5 |
| 96 h | 5/5 | 0/5 | 1/5 | 0/5 | 5/5 |
| 168 h | 5/5 | 5/5 | 5/5 | 5/5 | 5/5 |
| Humidity resistance | | | | | |
| 100 h | 0/10 | 0/10 | 0/10 | 0/10 | 0/10 |
| 500 h | 0/10 | 0/10 | 0/10 | 0/10 | 0/10 |
| 1000 h | 0/10 | 1/10 | 0/10 | 0/10 | 0/10 |
| 1500 h | 0/10 | 3/10 | 1/10 | 1/10 | 0/10 |
| 2000 h | 0/10 | 8/10 | 2/10 | 3/10 | 0/10 |
| 3000 h | 0/10 | 10/10 | 5/10 | 7/10 | 0/10 |
| High-temperature- | | | | | |
| standing property | | | | | |
| 500 h | 2/10 | 0/10 | 0/10 | 0/10 | 0/10 |
| 1000 h | 10/10 | 0/10 | 0/10 | 0/10 | 0/10 |
| 1500 h | 10/10 | 0/10 | 0/10 | 0/10 | 0/10 |
| 2000 h | 10/10 | 3/10 | 2/10 | 3/10 | 0/10 |

Of Comparative Examples 1 to 9, into which the compound (C) represented by the general formula (I) in the present invention was not incorporated, Comparative Examples 1, 2, 4, 5, 7, 8 and 9 were poor in flame retardancy, and the UL-94 V-0 was not attained. Comparative Examples 3 and 6, wherein the UL-94 V-0 was attained, were poor in curability. Of Comparative Examples 10 to 14, into which the compound (C) represented by the general formula (I) was not incorporated but one of the various flame retardants was incorporated, Comparative Examples 11 to 13 were poor in humidity resistance. Moreover, Comparative Example 14 was poor in reflow resistance. Furthermore, Comparative Example 10 attained the V-0, but was poor in high-temperature standing property and reflow resistance.

On the other hand, about all of Examples 1 to 27, which each contained the compound (C) represented by the general formula (I), the UL-94 V-0 was attained. Thus, the flame retardancy was good, and the moldability was also good. Furthermore, the reflow resistance was excellent, and the reliabilities, such as the humidity resistance and the high-temperature-standing property, were also excellent.

### INDUSTRIAL APPLICABILITY

The epoxy resin composition for sealing according to the invention is good in flame retardancy, and can give an electron component device or some other product excellent in reliabilities. Thus, the invention has a large industrial value.

1. An epoxy resin composition for sealing comprising (A) an epoxy resin, and (B) a curing agent, wherein the following is comprised as the curing agent (B): (C) a compound or compounds represented by the following general formula (I) in which n is or n's are each an integer of 1 to 10, and m is or m's are each an integer of 1 to 10: 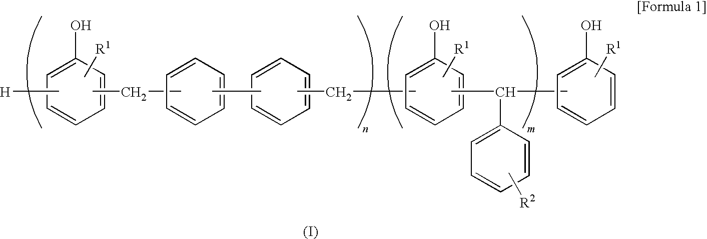
wherein R¹ is selected from a hydrogen atom and substituted or unsubstituted monovalent hydrocarbon groups having 1 to 10 carbon atoms, and R² is selected from a hydrogen atom and substituted or unsubstituted monovalent hydrocarbon groups having 1 to 10 carbon atoms.

2. The epoxy resin composition for sealing according to claim 1, wherein the ratio between the average N of n's of the compounds represented by the general formula (I) and the average M of m's of the compounds, the ratio of M/(N+M), is from 0.05 to 0.5.

3. The epoxy resin composition for sealing according to claim 1, wherein the ratio between the average N of n's of the compounds represented by the general formula (I) and the average M of m's of the compounds, the ratio of M/(N+M), is from 0.1 to 0.3.

4. The epoxy resin composition for sealing according to any one of claims 1 to 3, wherein the epoxy resin (A) comprises at least one of biphenyl type epoxy resin, bisphenol F type epoxy resin, stylbene type epoxy resin, sulfur-atom-containing epoxy resin, Novolak type epoxy resin, dicyclopentadiene type epoxy resin, naphthalene type epoxy resin, triphenylmethane type epoxy resin, biphenylene type epoxy resin, and naphthol/aralkyl type phenol resin.

5. The epoxy resin composition for sealing according to any one of claims 1 to 3, wherein the compound(s) (C) represented by the general formula (I) is/are contained in the curing agent (B) in an amount of 40 to 100% by mass.

6. The epoxy resin composition for sealing according to any one of claims 1 to 3, wherein the compound(s) (C) represented by the general formula (I) is/are contained in the curing agent (B) in an amount of 60 to 100% by mass.

7. The epoxy resin composition for sealing according to any one of claims 1 to 3, wherein the curing agent (B) comprises at least one of biphenylene type phenol/aralkyl resin, phenol/aralkyl resin, naphthol/aralkyl resin, dicyclopentadiene type phenol resin, triphenylmethane type phenol resin, and Novolak type phenol resin.

8. The epoxy resin composition for sealing according to any one of claims 1 to 3, further comprising (D) a curing promoter.

9. The epoxy resin composition for sealing according to claim 8, wherein the curing promoter (D) is triphenylphosphine.

10. The epoxy resin composition for sealing according to claim 8, wherein the curing promoter (D) is an adduct of a tertiary phosphine compound and a quinone compound.

11. The epoxy resin composition for sealing according to any one of claims 1 to 3, further comprising (E) an inorganic filler.

12. The epoxy resin composition for sealing according to claim 11, wherein the content by percentage of the inorganic filler (E) is from 60 to 95% by mass of the epoxy resin composition for sealing.

13. The epoxy resin composition for sealing according to claim 11, wherein the content by percentage of the inorganic filler (E) is from 70 to 90% by mass of the epoxy resin composition for sealing.

14. The epoxy resin composition for sealing according to any one of claims 1 to 3, further comprising (F) a coupling agent.

15. The epoxy resin composition for sealing according to claim 14, wherein the coupling agent (F) comprises a silane coupling agent having a secondary amino group.

16. The epoxy resin composition for sealing according to claim 15, wherein the silane coupling agent having a secondary amino group comprises a compound represented by the following general formula (II): 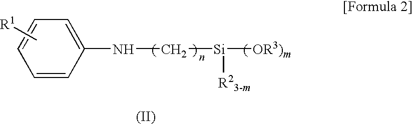
wherein R¹ is selected from a hydrogen atom, and alkyl groups having 1 to 6 carbon atoms, and alkoxy groups having 1 to 2 carbon atoms, R² is selected from alkyl groups having 1 to 6 carbon atoms, and a phenyl group, R³ is selected from a methyl group or an ethyl group, n represents an integer of 1 to 6, and m represents an integer of 1 to 3.

17. An electron component device equipped with an element sealed with the epoxy resin composition for sealing according to any one of claims 1 to 3.
